(19) United States
(12) Patent Application Publication
(10) Pub. No.: US 2010/0312155 A1
(43) Pub. Date: Dec. 9, 2010

(54) MASSAGE MACHINE AND CHAIR-TYPE MASSAGE APPARATUS

(75) Inventors: Yoshifumi Fukuyama, Tottori (JP); Daisuke Shinomiya, Osaka (JP)

Correspondence Address: DRINKER BIDDLE & REATH (DC), 1500 K STREET, N.W., SUITE 1100, WASHINGTON, DC, 20005-1209, US

(73) Assignee: Family Co., Ltd., Osaka-shi (JP)

(21) Appl. No.: 12/745,498

(22) PCT Filed: Nov. 18, 2008
(86) PCT No.: PCT/JP2008/070890

§ 371 Date: May 28, 2010

(30) Foreign Application Priority Data
Nov. 29, 2007 (JP) 2007-309126

(51) Int. Cl. A61H 7/00

(52) U.S. Cl. 601/98

(57) ABSTRACT

A massage machine equipped with air cells (23a, 23b) disposed opposite to each other at a given distance therebetween in the up-down direction, a pair of support plates (22, 22) for supporting the air cells (23a, 23b) from the outside in the up-down direction, a pair of rotation portions (21) for applying a drive force to the pair of support plates (22, 22) in the front-rear direction and for supporting the support plates (22, 22) on both the left and right sides, guide portions (25) formed in the pair of rotation portions (21) to support the pair of support plates (22) so that the pair of support plates is movable in a direction in which the support plates (22) approach and separate from each other, biasing portions (26) for biasing the pair of support plates (22) in a direction in which the support plates approach each other, and a drive unit (28) for applying a rotation drive force to the rotation portions (21).

### TECHNICAL FIELD

The present invention relates to a massage machine and a chair-type massage apparatus capable of performing stroke massage to the user.

### BACKGROUND ART

As a conventionally known massage machine capable of performing stroke massage to the user, the massage machine disclosed in JP-2004-202207-A is available.

The footrest of the massage machine described in this document has a support base for supporting a treatment site and a movement portion disposed so as to be opposed to the support base so that the treatment site is held therebetween. The movement portion has a roller that is movable in the longitudinal direction of the treatment site, and the support base and the roller each have an air bag constituting a treatment unit.

Furthermore, in this massage machine, the treatment units provided on the support base and the roller of the movement portion hold the treatment site therebetween and apply pressing stimulus to the treatment site. Moreover, operation for continuously changing the treatment-site pressing stimulus position can be performed by moving the roller in the longitudinal direction of the treatment site and by rolling the roller over the treatment site. This operation is the so-called stroke massage.

### DISCLOSURE OF THE INVENTION

The above-mentioned massage machine has a structure in which, among the support base and the roller of the movement portion each having the treatment unit, the roller-side treatment unit is movable in the longitudinal direction of the treatment site, and the other support-base-side treatment unit is secured.

In this case, the treatment-site pressing stimulus position is changed continuously by moving and rolling the roller in the longitudinal direction of the treatment site. Hence, stroke massage is performed on the treatment site. In other words, the effect of stroke massage is obtained only on the roller side of the treatment site; for this reason, for the purpose of performing stroke massage on the support base side of the treatment site, it is necessary to move the treatment site to the roller side. In other words, it is necessary to change the orientation of the treatment site.

As a result, the number of times the massage is performed on the treatment site increases, and the time required for the stroke massage is prolonged. Furthermore, when the treatment site is a leg, the orientation of the leg cannot be changed when the user is sitting on a chair-type massage apparatus.

Furthermore, in this case, since the roller of the movement portion is moved in the longitudinal direction of the treatment site while a given distance is provided between the roller and the support base regardless of the size of the treatment site, the intensity of the pressing stimulus applied from the roller-side treatment unit to the treatment site changes depending on the size of the treatment site. In particular, when the treatment site is a leg, since the size of the calf is quite different from the size of the portion near the ankle, when the given distance is set to the size of the calf, the roller-side treatment unit cannot press the portion near the ankle. Conversely, when the given distance is set to the size of the portion near the ankle, the pressing stimulus of the roller-side treatment unit is excessive at the calf portion.

For this reason, even when massage is performed on the treatment site, the massage effect is limited to only a part of the treatment site.

Accordingly, in consideration of the above-mentioned problems, the present invention is intended to provide a massage machine and a chair-type massage apparatus capable of efficiently performing stroke massage by making a pair of treatment units disposed opposite to each other hold a treatment site therebetween from both sides and by reciprocating both the treatment units together and capable of obtaining a favorable stroke massage effect by making the pair of treatment units into contact with the entire treatment site at all times and by applying pressing stimulus to the treatment site at all times.

The present invention is characterized to include a first pressing member, a second pressing member disposed to be opposed to the first pressing member with a distance so that a treatment site is disposed therebetween, a support member that supports both the pressing members so that both the pressing members are movable in a first direction in which both the pressing members approach and separate from each other and in a second direction nearly perpendicular to the first direction, biasing portions that bias both the pressing members in the direction in which both the pressing members approach each other, and a stroke drive unit that performs a stroke massage on the treatment site using both the pressing members by respectively reciprocating both the pressing members biased using the biasing portions in the second direction.

With the massage machine according to the present invention, both the pressing members biased using the biasing portions in the direction in which the pressing members approach each other can hold the treatment site and apply the pressing stimulus to the treatment site from both sides. In addition, since both the pressing members make contact with the treatment site by the biasing portions, when both the pressing members reciprocate in the second direction, that is, in the longitudinal direction of the treatment site, both the pressing members can move along the contour of the treatment site. In this case, both the pressing members make contact with the treatment site at all times, and both the pressing members operate to repeatedly stroke the contour of the treatment site from both sides to apply pressing stimulus at all times.

In the massage machine, it is preferable that the support member includes a first support member provided to support the pressing members so as to be movable in the first direction together with the pressing members and a second support member supporting the first support member so as to move the first support member in the second direction by being driven by the drive unit, and that the second support member has a guide portion to support the first support member so as to be movable in the first direction.

In this case, since the second support member driven by the drive unit apply a drive force to the first support member and the pressing members, the pressing members can move in the second direction. Furthermore, the first support member is supported so as to be movable in the first direction by the guide portion of the second support member. In other words, the movement range of the first support member is restricted by the guide portions.

That is to say, the first pressing member and the second pressing member supported on the first support member can be prevented from approaching too close to each other and separating too far from each other. Hence, excessive pressing stimulus to the treatment site due to the pressing members approaching too close to each other does not occur. Alternatively, the impossibility of the pressing to the treatment site due to the pressing members separating too far from each other does not occur.

Moreover, in the massage machine, it is preferable that the support member is configured so that an opposed distance between the first pressing member and the second pressing member is adjustable.

In this case, since the opposed distance between both the pressing members can be adjusted depending on the size of the treatment site, effective stroke massage can be performed regardless of the size of the treatment site.

Still further, it is preferable that the massage machine has a pressing direction adjustment portion that changes the first direction in which both the pressing members approach and separate from each other.

In this case, since the first direction is changed, that is, since the positions of both the pressing members for holding the treatment site therebetween in the circumferential direction of the treatment site can be changed, massage can be performed in a wide range in the circumferential direction of the treatment site.

In addition, in the massage machine, it is preferable that the pressing direction adjustment portion further includes a pressing direction adjustment drive portion that generates a drive force to change the first direction and a control portion that changes the first direction by operating the pressing direction adjustment drive portion while performing the stroke massage on the treatment site using both the pressing members by driving the stroke drive unit.

In this case, while stroke massage is performed on the treatment site by reciprocating both the pressing members in the second direction, the positions of both the pressing members for holding the treatment site therebetween can be further changed in the circumferential direction of the treatment site. Hence, massage can be performed continuously in a wide range in the circumferential direction of the treatment site.

Furthermore, it is preferable that the massage machine further includes a stroke range adjustment portion that moves a stroke range in which both the pressing members reciprocate in the second direction by the stroke drive unit in the second direction.

In this case, the position of the stroke range is changed in the second direction. In other words, since the positions of both the pressing members for holding the treatment site therebetween can be changed in the longitudinal direction of the treatment site, massage can be performed in a wide range in the longitudinal direction of the treatment site.

Moreover, in the massage machine, it is preferable that the stroke range adjustment portion further includes a position changing drive portion that generates a drive force to move the stroke range in the second direction and a control portion that moves the position of the stroke range in the second direction by operating the position changing drive portion while performing the stroke massage on the treatment site using both the pressing members by driving the stroke drive unit.

In this case, while stroke massage is performed on the treatment site by reciprocating both the pressing members in the second direction or while stroke massage is performed on the treatment site by reciprocating both the pressing members in the second direction and by changing the positions of both the pressing members for holding the treatment site therebetween in the circumferential direction of the treatment site, the positions of both the pressing members for holding the treatment site therebetween can be further changed in the longitudinal direction of the treatment site. Hence, stroke massage can be performed continuously in a wide range in the circumferential direction of the treatment site or in a wide range in the circumferential direction and the longitudinal direction of the treatment site.

Still further, it is preferable that the massage machine has a pressing direction adjustment portion including a pressing direction adjustment drive portion that generates a drive force to change the first direction in which both the pressing members approach and separate from each other and a control portion that changes the first direction by operating the pressing direction adjustment drive portion while performing the stroke massage on the treatment site using both the pressing members by driving the stroke drive unit, and has a stroke range adjustment portion including a position changing drive portion that generates a drive force to move a stroke range in which both the pressing members reciprocate in the second direction by the stroke drive unit in the second direction and a control portion that moves the position of the stroke range in the second direction by operating the position changing drive portion while performing the stroke massage on the treatment site using both the pressing members by driving the stroke drive unit.

In this case, while stroke massage is performed on the treatment site by reciprocating both the pressing members in the second direction, the positions of both the pressing members for holding the treatment site therebetween can be changed in the circumferential direction of the treatment site, and the positions of both the pressing members for holding the treatment site therebetween can be further changed in the longitudinal direction of the treatment site. Hence, massage can be performed continuously in a wide range in the circumferential direction and the longitudinal direction of the treatment site.

### BRIEF DESCRIPTION OF THE DRAWINGS

FIG. 1 is a perspective view showing a chair-type massage apparatus equipped with a first embodiment of a massage machine according to the present invention;

FIG. 2 is a perspective view showing an arm massage machine according to the first embodiment, the cover thereof being open;

FIG. 3 is a side sectional view showing the arm massage machine according to the first embodiment, the cover thereof being closed;

FIG. 4 is a sectional view taken on line A-A of FIG. 3;

FIGS. 5A and 5B are explanatory views showing the motion of the arm massage machine according to the first embodiment;

FIG. 6 is a perspective view showing a leg massage machine according to the first embodiment;

FIG. 7 is a control block diagram of the leg massage machine and arm massage machine according to the first embodiment;

FIG. 8 is a perspective view showing an arm massage machine according to a second embodiment, the cover thereof being open;

FIG. 9 is a sectional view taken on line B-B of FIG. 8;

FIG. 10 is a sectional view taken on line C-C of FIG. 9;

FIG. 11 is a sectional view taken on line D-D of FIG. 9;

FIGS. 12A and 12B are explanatory views showing the motion of the arm massage machine according to the second embodiment;

FIGS. 13A and 13B are explanatory views illustrating a procedure for adjusting the opposed distance between a pair of treatment devices in the arm massage machine according to the second embodiment;

FIGS. 14A and 14B are explanatory views illustrating the next procedure for adjusting the opposed distance between the pair of treatment devices in the arm massage machine according to the second embodiment;

FIG. 15 is a control block diagram of the arm massage machine according to the second embodiment;

FIG. 16 is a perspective view showing an arm massage machine according to a third embodiment, the cover thereof being open;

FIG. 17 is a side sectional view showing the arm massage machine according to the third embodiment, the cover thereof being closed;

FIG. 18 is a sectional view taken on line E-E of FIG. 17;

FIG. 19 is a sectional view showing the arm massage machine of FIG. 18, rotated in the circumferential direction;

FIG. 20 is a control block diagram of the arm massage machine according to the third embodiment;

FIG. 21 is a side sectional view showing an arm massage machine according to a fourth embodiment, the cover thereof being closed;

FIG. 22 is a sectional view taken on line F-F of FIG. 21;

FIG. 23 is a sectional view showing a state in which the arm massage machine of FIG. 22 is tilted sideways 90 degrees;

FIG. 24 is a control block diagram of the arm massage machine according to the fourth embodiment;

FIG. 25 is a perspective view showing an arm massage machine according to a fifth embodiment, the cover thereof being open;

FIG. 26 is a sectional view taken on line G-G of FIG. 25;

FIGS. 27A and 27B are explanatory views illustrating the reciprocation stroke motion of the arm massage machine according to the fifth embodiment;

FIG. 28 is a control block diagram of the arm massage machine according to the fifth embodiment;

FIG. 29 is a perspective view showing an arm massage machine according to a sixth embodiment;

FIGS. 30A and 30B are explanatory view illustrating the helical stroke motion of the arm massage machine according to the sixth embodiment; and

FIG. 31 is a control block diagram of the arm massage machine according to the sixth embodiment.

### BEST MODES FOR CARRYING OUT THE INVENTION

Embodiments according to the present invention will be described below on the basis of the drawings.

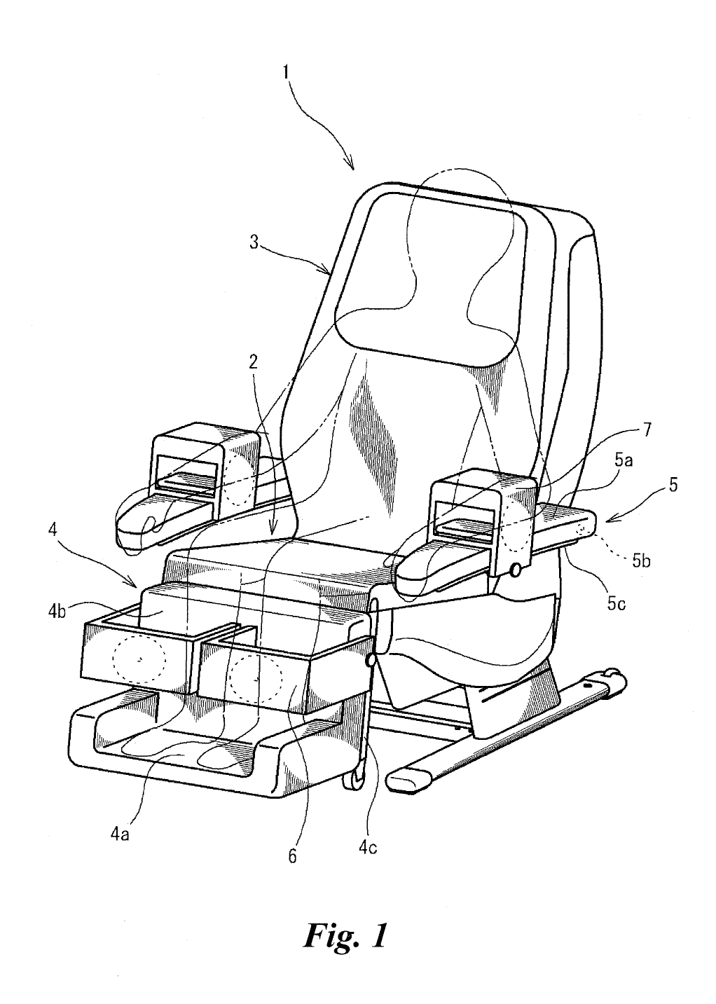

FIGS. 1 to 7 show a first embodiment of a massage machine according to the present invention.

FIG. 1 is a perspective view showing a chair-type massage apparatus 1 equipped with the massage machine according to the first embodiment. This chair-type massage apparatus includes a seat section 2, a backrest section 3 disposed behind the seat section 2, a footrest section 4 disposed in front of the seat section, and armrest sections 5 disposed on both the left and right sides of the seat section 2.

In this embodiment, the height direction of the backrest section 3 being in the state shown in FIG. 1 is the up-down direction thereof, the depth direction thereof is referred to as the front-rear direction, and the width direction of the backrest section 3 as viewed from the front is referred to as the left-right direction.

The backrest section 3 is installed on the seat section 2 so that it can be reclined (rotated) backward.

The footrest section 4 is installed on the seat section 2 so as to be rotatable therearound from the downward hanging state shown in FIG. 1 to a forward protruding state, not shown.

When the backrest section 3 is reclined backward and the footrest section 4 is moved up, the range from the backrest section 3 to the footrest section 4 becomes nearly flat, and the user can lie on his or her back. Treatment units (not shown) are disposed in any or all of the seat section 2, the backrest section 3 and the footrest section 4, and massage can be performed for the user being sitting or lying on his or her back. Various devices, such as massaging balls that are driven using a motor and air cells that are expanded/contracted by supplying/exhausting air, can be adopted as the treatment units.

The footrest section 4 has a sole portion 4a for supporting the left and right soles, that is, the lower end portion thereof being protruded forward, a leg placement main body portion 4b for supporting both the left and right legs, and guide rails 4c disposed in the rear portion thereof in the up-down direction. Left and right leg massage machines 6 described later are installed on the leg placement main body portion 4b.

The rear portions of the armrest sections 5 are installed on the left and right side faces of the backrest section 3 at both the left and right side positions of the seat section 2 and extended forward. The armrest section 5 has an armrest main body portion 5a for supporting an arm, a shaft 5b provided in the rear portion thereof in the left-right direction, and guide rails 5c disposed in the lower portion thereof in the front-rear direction. Arm massage machines 7 described later are respectively installed on the left and right armrest main body portions 5a.

Since the shaft 5b is pivoted at a backrest frame (not shown) serving as a framework for the backrest section inside the backrest section 3, the armrest section 5 is rotatable around the shaft 5b. Hence, the armrest section 5 can take a state in which the front portion thereof is directed nearly forward as shown in FIG. 1 and a state, not shown, in which the front portion thereof is rotated backward and raised so as to be directed upward.

When the armrest sections 5 are obstructive or when the user wishes to take or leave the seat section 2 sideways, the armrest section 5 can be made to not present on one side of the seat section 2 by rotating the armrest section 5. Hence, the user can easily take or leave the seat section sideways.

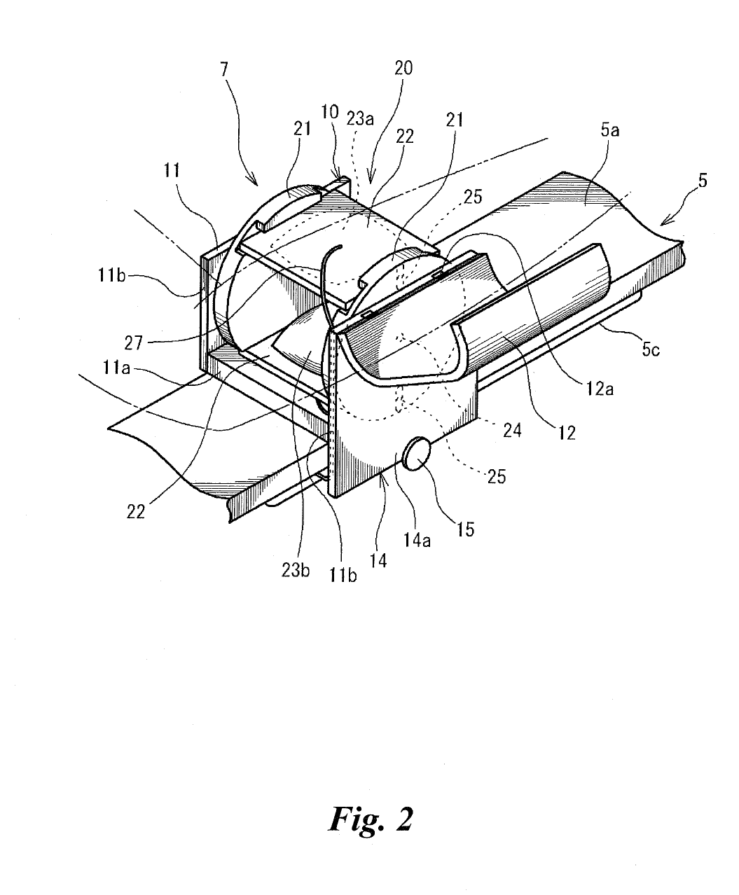

FIGS. 2 to 4 show a right arm massage machine 7 installed on the armrest main body portion 5a. This right arm massage machine 7 is equipped with an outer frame 10 opened in the front-rear direction and a massaging mechanism 20 for performing a stroke massaging motion. The outer frame 10 has an accommodation portion 11, opened in the upper portion thereof and in the front-rear direction, for accommodating the massaging mechanism 20, a cover portion 12 for covering the upper portions of the accommodation portion 11 and the massaging mechanism 20 accommodated, and an installation portion 14 for installation on the armrest section 5.

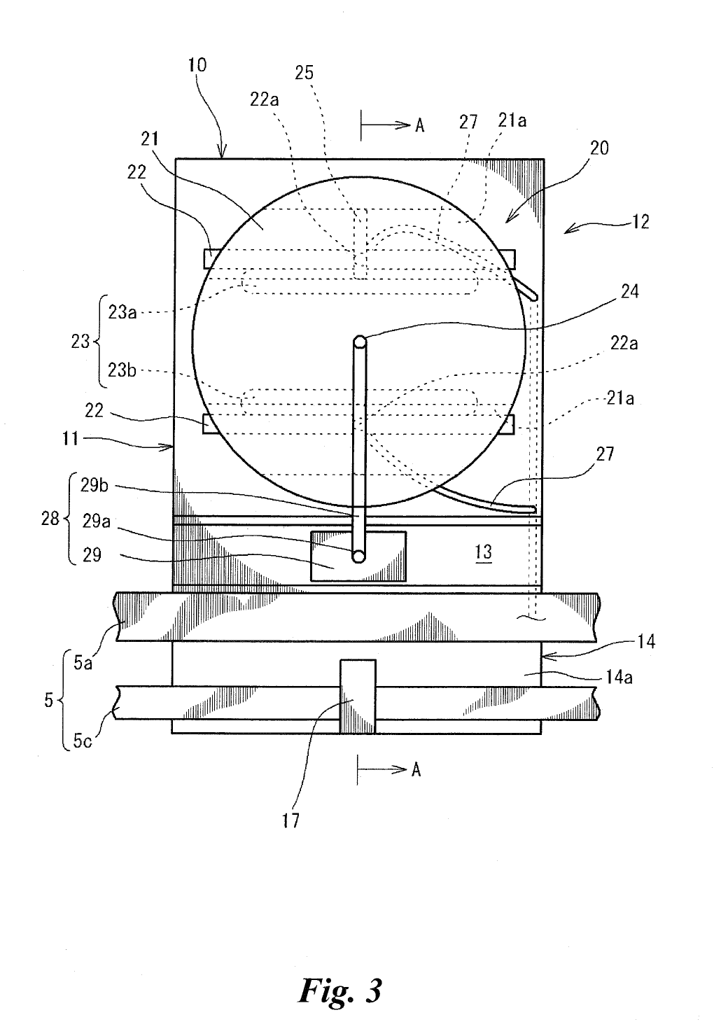

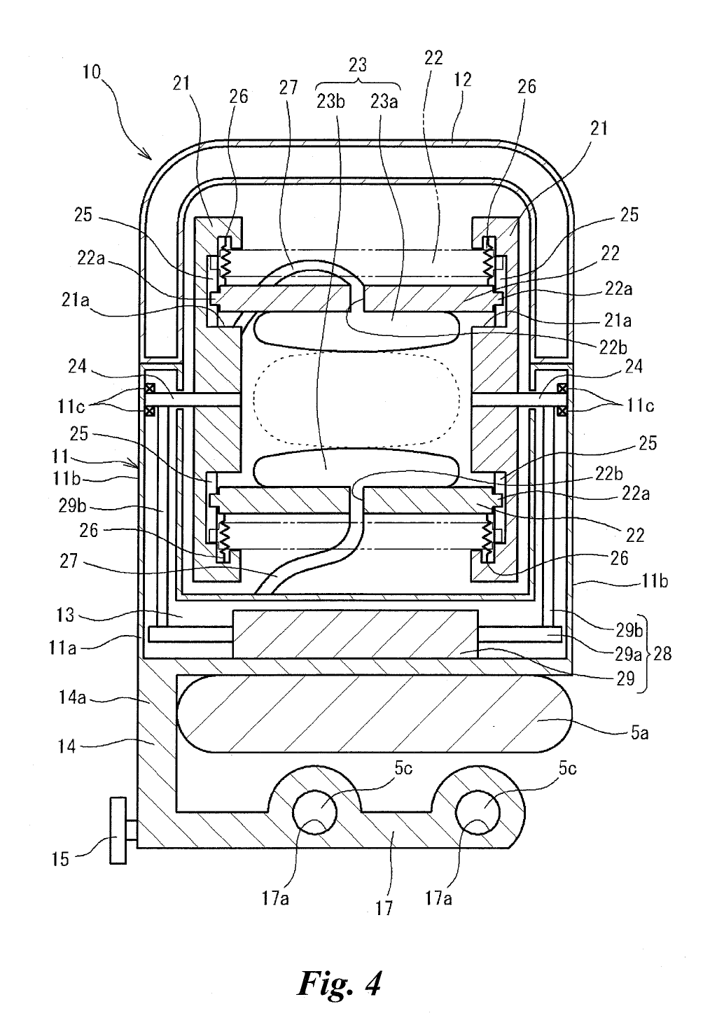

The accommodation portion 11 has a bottom portion 11a mounted on the armrest main body portion 5a and left and right side portions 11b protruding upward from both the left and right ends of the bottom portion 11a. The bottom portion 11a has a space therein, while the left and right side portions 11b each have a space therein. And, the inner space of the bottom portion 11a communicates with the inner spaces of the left and right side portions 11b. The inner space of the bottom portion 11a and the inner spaces of the left and right side portions 11b communicating therewith constitute a drive chamber 13 for accommodating a drive unit (a stroke drive unit) 28 for applying a drive force to the massaging mechanism 20 described later (see FIGS. 3 and 4).

In addition, inside the inner spaces of the left and right side portions 11b, support portions 11c each formed of a bearing are provided. The massaging mechanism 20 is supported on the left and right support portions 11c and accommodated inside the area enclosed by the bottom portion 11a and the left and right side portions 11b.

The cover portion 12 is connected to the upper face of the left side portion of the accommodation portion 11 via hinges 12a, and when the cover portion 12 is closed, it is secured to the accommodation portion 11 with a fastener (not shown).

The installation portion 14 is equipped with a side portion 14a protruding downward from the left side end portion of the bottom portion 11a, a guide portion 17 extending from the center in the front-rear direction of the lower end portion of the side portion 14a to the center in the left-right direction thereof, and a fixture 15 for securing the guide portion 17 to the armrest section 5. The guide portion 17 has guide holes 17a, and the guide rails 5c of the armrest section 5 are slidably inserted into the guide holes 17a. Hence, the guide portion 17 is movable along the guide rails 5c in the front-rear direction. Hence, the outer frame 10 can be moved in the front-rear direction of the armrest section 5. Furthermore, the guide portion 17 is secured to the guide rails 5c with the fixture 15.

Next, the massaging mechanism 20 will be described. The massaging mechanism 20 is equipped with a pair of air cells 23 disposed opposite to each other at a given distance therebetween in the up-down direction, a pair of support plates (a first support: a support member) 22 for supporting the pair of air cells 23 from the outside in the up-down direction, a pair of rotation portions (a second support: a support member) 21 for applying a drive force to the pair of support plates 22 in the front-rear direction (a second direction) and for supporting the support plates 22 on both the left and right sides, guide portions 25 formed in the pair of rotation portions 21 to support the pair of support plates 22 so that the pair of support plates 22 is movable in a direction (a first direction) in which the support plates 22 approach and separate from each other, biasing portions 26 for biasing the pair of support plates 22 in a direction in which the support plates approach each other, rotation shafts 24 provided in the pair of rotation portions 21, and a drive unit 28 for applying a rotation drive force to the rotation shafts 24.

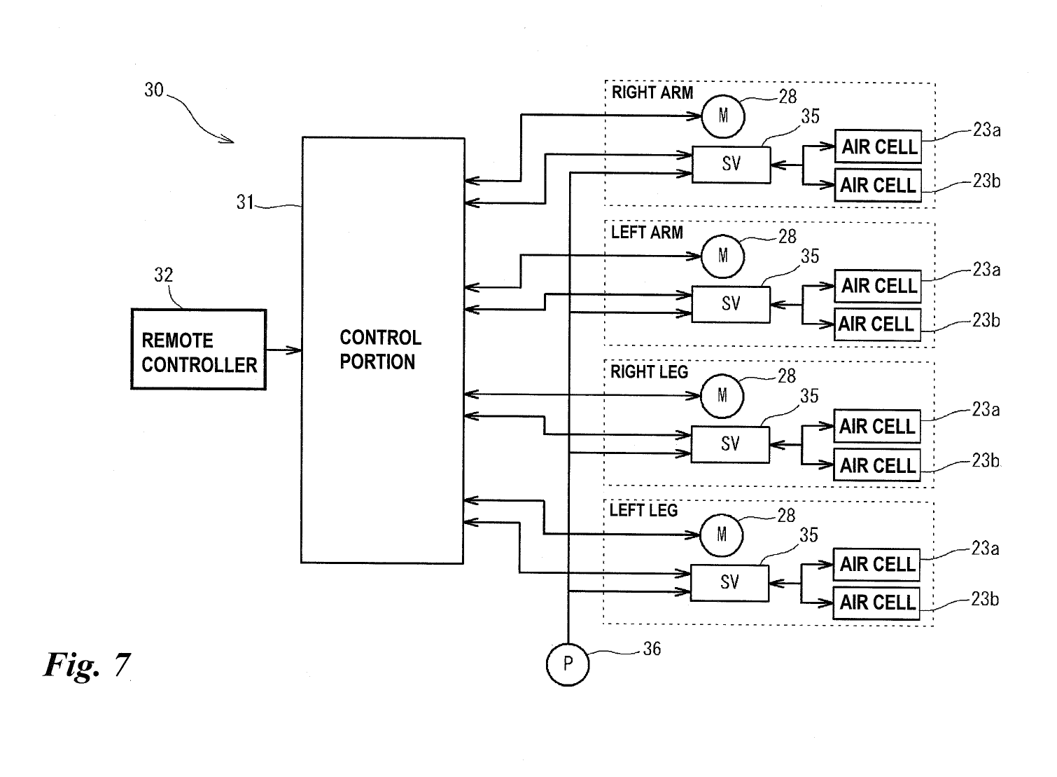

The pair of air cells 23 has a first air cell (a first pressing member) 23a for pressing a treatment-site arm from above and a second air cell (a second pressing member) 23b for pressing the arm from below. The air cells 23a and 23b each have an air tube 27 through which air is supplied/exhausted. Each of the air tubes 27 is inserted into the hole portion 22b of the support plate 22 described later, passes through the drive chamber 13 of the outer frame 10, is routed (not shown) below the armrest section 5, and is connected to an air supplying/exhausting apparatus 36 (see FIG. 7) disposed below the seat section 2. The intensity of the pressing stimulus applied to the arm can be changed depending on the air supply amount to the air cells 23a and 23b.

Each of the support plates 22 has left and right shaft portions 22a protruding both the left and right side faces thereof at the center portions in the front-rear direction and the hole portion 22b passing through in the up-down direction. Each of the shaft portions 22a is supported with the guide portion 25, and a drive force is applied thereto from the rotation portion 21 in the front-rear direction. Hence, each of the support plates 22 reciprocates in the front-rear direction. In this case, since each of the support plates 22 is supported at one point in the front-rear direction, the end portions in the front-rear direction of the support plates 22 are tiltable. The air tubes 27 of the air cells 23 supported on the opposed faces of the support plates 22 are inserted into the hole portions 22b, and the air tubes 27 are guided to the sides of the other faces of the support plates 22 so as to be connected to the air supplying/exhausting apparatus 36 (see FIG. 7).

The rotation portions 21 are each formed of a circular plate member. On the opposing inner faces thereof, there are provided the rotation portions 21 each have the biasing portions 26, the guide portions 25, and restriction grooves 21a having a given width and formed in the front-rear direction to restrict the up-down movement of the support plates 22 during the reciprocation movement thereof. The restriction grooves 21a are indicated by broken lines in FIG. 3 and formed in the upper portion and the lower portion of each of the rotation portions 21. During the reciprocation movement of the support plates 22 in the front-rear direction, the up-down movement of each of the support plates 22 is restricted within the width of the restriction groove 21a. Hence, each of the support plates 22 is prevented from being tilted more than necessary from the horizontal direction, and a strong pressing stimulus is prevented from being applied to the arm.

The guide portions 25 each have grooves in the radial direction and in the up-down direction of the rotation portion 21, and these grooves are formed in the upper portion and the lower portion of the rotation portions 21. The shaft portions 22a of the support plates 22 are accommodated in the grooves of the guide portions 25, and the support plates 22 are supported so as to be movable within the length of each of the grooves in a direction in which the support plates approach each other, that is, in the up-down direction.

Furthermore, the guide portions 25 restrict the shaft portions 22a from moving in the up-down direction beyond the given range. In other words, the wall faces of the grooves of the guide portions 25 serve as stoppers, thereby preventing the shaft portions 22a from moving beyond the wall faces of the grooves of the guide portions 25. Hence, the support plates 22 are prevented from excessively approaching each other and an excessively strong pressing stimulus is prevented from being applied from the air cells 23a and 23b to the arm. Alternatively, the support plates 22 are prevented from separating excessively from each other and the air cells 23a and 23b are prevented from being unable to press the arm.

Moreover, the wall faces of the grooves of the guide portions 25 apply a pressing force in the front-rear direction to the shaft portions 22a by the rotation of the rotation portions 21. In other words, a drive force for reciprocating the support plates 22 in the front-rear direction is applied to the shaft portions 22a. Since the shaft portions 22a are movable with respect to the guide portions 25 in the given range in the up-down direction at this time, the circular motional locus of each of the rotation portions 21 can be converted into the linear motional locus of each of the support plates 22 or a locus along the contour of the treatment-site arm. In other words, when the rotation of the rotation portions 21 are converted into the reciprocation movement of the support plates 22 in the front-rear direction, the up-down direction movement of the support plates 22 can be absorbed.

The biasing portions 26 are formed of a spring and provided at the top portion and the bottom portion of each of the rotation portions 21 as shown in FIG. 4. In addition, the biasing portions 26 provided at the top portions of the rotation portions 21 are installed at both the left and right end portions of the center portion in the front-rear direction of the upper face of the upper support plate 22. The biasing portions 26 provided at the bottom portions of the rotation portions 21 are installed at both the left and right end portions of the center portion in the front-rear direction of the lower face of the lower support plate 22.

In this case, the biasing forces of the biasing portions 26 are set to the extent that the support plates 22 and the air cells 23a and 23b respectively approach and separate from each other depending on the size of the treatment-site arm. For this reason, the support plates 22 are biased by the biased portions 26 in a direction in which the support plates approach each other. In other words, the air cells 23a and 23b are biased in the up-down direction toward the arm, whereby the opposed distance between the support plates 22 and the opposed distance between the air cells 23a and 23b are adjusted depending on the size of the arm. Furthermore, since the support plates 22 and the air cells 23a and 23b are allowed to move outward in the up-down direction by the biasing portions 26 formed of a spring, reciprocation movement along the contour of the arm can be attained regardless of the size of the arm. Hence, the air cells 23a and 23b can make contact with the arm at all times and can apply a constant pressing stimulus at all times.

One end of the rotation shaft 24 is secured to the circular center portion of the rotation portion 21, and the other end thereof is rotatably supported on the support portion 11c of the accommodation portion 11.

The drive unit 28 is equipped with a motor 29 having a rotation drive force in a forward-reverse direction, motor shafts 29a protruding from both the left and right end portions of the motor 29, and belts 29b for transmitting the rotation movements of the motor shafts 29a. The belts 29b are respectively wound around the left and right motor shafts 29a and the rotation shafts 24. The rotation drive force in the forward-reverse direction of the motor 29 rotates the rotation shafts 24 and the rotation portions 21 in the forward-reverse direction and reciprocates the support plates 22 and the air cells 23a and 23b.

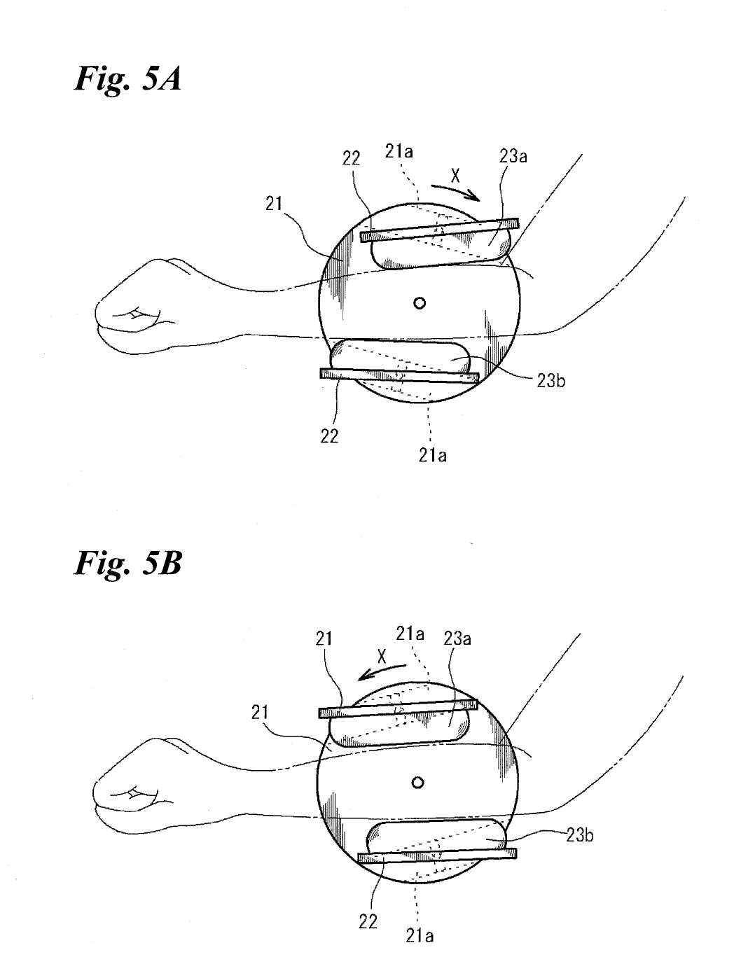

FIGS. 5A and 5B show the stroke massaging motion of the arm massage machine 7.

FIG. 5A shows a state in which the upper portion of each of the rotation portions 21 is rotated backward as indicated by arrow X. The air cells 23a and 23b hold the arm therebetween in the up-down direction by the biasing portions 26 (not shown), and the air cells 23a and 23b make contact with the arm along the contour thereof. Furthermore, the air cell 23a moves backward and the air cell 23b moves forward along the contour of the arm to apply the constant pressing stimulus in a contact range therebetween.

FIG. 5B shows a state in which the upper portion of each of the rotation portions 21 is rotated forward as indicated by arrow X. Also in this case, the air cells 23a and 23b hold the arm therebetween in the up-down direction by the biasing portions 26 (not shown), and the air cells 23a and 23b make contact with the arm along the contour thereof. Furthermore, the air cell 23a moves forward and the air cell 23b moves backward along the contour of the arm to apply the constant pressing stimulus in a contact range therebetween.

In addition, the change between the state shown in FIG. 5A and the state shown in FIG. 5B is described; the air cell 23a changes the movement direction from the backward movement to the forward movement and the air cell 23b changes the movement direction from the forward movement to the backward movement, thereby each reciprocating in the front-rear direction. In this case, since the air cells 23a and 23b remain biased by the biasing portions 26 (not shown), the air cells make contact with the arm at all times and reciprocate to apply the constant pressing stimulus at all times. As a result, the contour of the arm is stroked with the air cells 23a and 23b. Furthermore, this reciprocation movement is repeated to perform a stroke massaging motion.

The right arm massage machine 7 has been described in FIGS. 2 to 5B; since the left arm massage machine 7 has the same configuration as that of the right arm massage machine 7, except that the respective components thereof are just opposite in the left-right direction, the detailed description thereof is omitted.

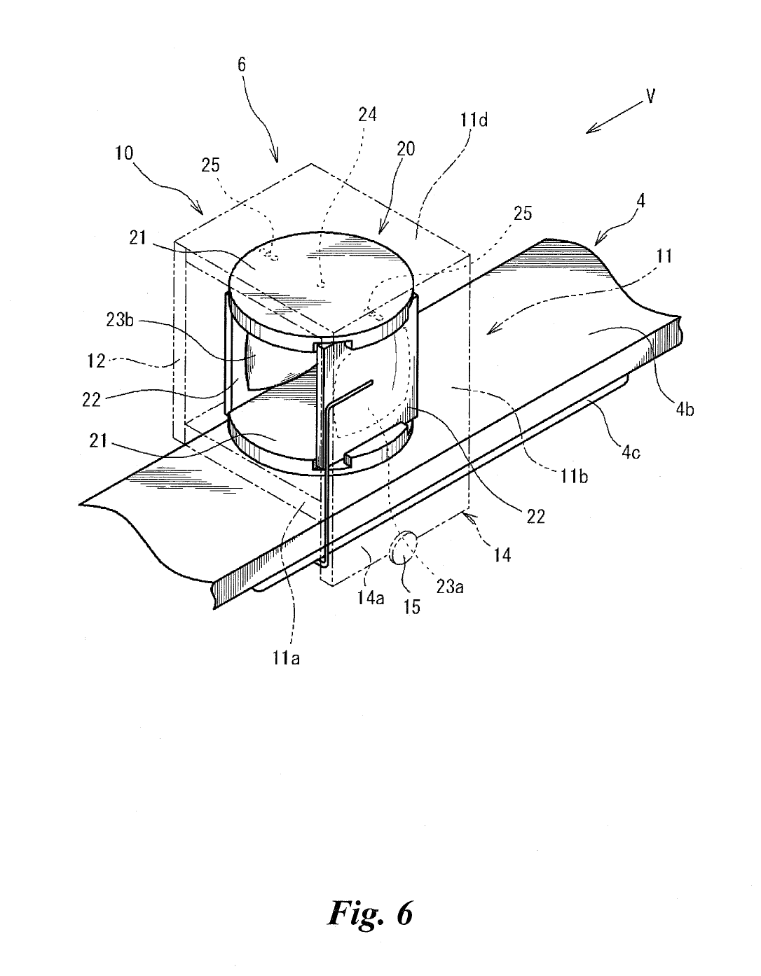

FIG. 6 shows a right leg massage machine 6 installed on the leg placement main body portion 4b in a forward protruding state (horizontal state) with respect to the seat section 2. The followings are explained while basically assuming a case in which the leg placement main body portion 4b is in the forward protruding state.

The massaging mechanism 20 of this leg massage machine 6 is equipped with a pair of air cells 23 disposed opposite to each other at a given distance therebetween in the left-right direction, a pair of support plates (a first support: a support member) 22 for supporting the pair of air cells 23 from the outside in the left-right direction, a pair of rotation portions (a second support: a support member) 21 for applying a drive force to the pair of support plates 22 in the front-rear direction (the second direction) and for supporting the support plates 22 on both the upper and lower sides, guide portions 25 formed in the pair of rotation portions 21 to support the pair of support plates 22 so that the pair of support plates 22 is movable in a direction (the first direction) in which the support plates 22 approach and separate from each other, biasing portions 26 (not shown) for biasing the pair of support plates 22 in a direction in which the support plates approach each other, rotation shafts 24 provided in the pair of rotation portions 21, and a drive unit 28 (not shown) for applying a rotation drive force to the rotation shafts 24.

In other words, the massaging mechanism 20 of the arm massage machine 7 shown in FIG. 2 has the air cells 23a and 23b for holding an arm in the up-down direction to perform stroking massage on both the upper and lower sides of the arm; on the other hand, the massaging mechanism 20 of the leg massage machine 6 shown in FIG. 6 has the air cells 23a and 23b for holding a leg in the left-right direction to perform stroking massage on both the left and right sides of the leg. The leg is inserted from an opening portion opened in the front-rear direction.

Since the massaging mechanism 20 does not differ from that of the arm massage machine 7 shown in FIG. 2 in other respects, the detailed description thereof is omitted.

In addition, the outer frame 10 of the leg massage machine 6 has an accommodation portion 11, opened in the front-rear direction, for accommodating the massaging mechanism 20, a cover portion 12 for covering the accommodation portion 11 and the massaging mechanism 20 accommodated, and an installation portion 14 for installation on the footrest section 4. The accommodation portion 11 has a bottom portion 11a disposed on the leg placement main body portion 4b, a side portion 11b protruding upward from the left side end portion of the bottom portion 11a as viewed from the front (as viewed from arrow V in FIG. 6), and an upper portion 11d extending rightward from the upper end portion of the side portion 11b. The cover portion 12 is connected to the right side end portion of the bottom portion 11a and the right side end portion of the upper portion 11d. Furthermore, the bottom portion 11a, the side portion 11b and the upper portion 11d each have a space therein, and the inner spaces of the bottom portion 11a, the side portion 11b and the upper portion 11d communicate with one another.

In addition, the inner space of the bottom portion 11a, the inner space of the side portion 11b and the inner space of the upper portion 11d communicating with one another constitute a drive chamber 13 (not shown) for accommodating a drive unit 28 for applying a drive force to the massaging mechanism 20.

Furthermore, inside the inner spaces of the bottom portion 11a and the upper portion 11d, support portions 11c (not shown) formed of a bearing are provided. The massaging mechanism 20 is supported on the upper and lower support portions 11c and accommodated inside the area enclosed by the bottom portion 11a, the upper portion 11d and the upper portion 11d.

The installation portion 14 is equipped with a side portion 14a protruding downward from the left side end portion of the bottom portion 11a, a guide portion 17 (not shown) extending rightward from the center in the front-rear direction of the lower end portion of the side portion 14a, and a fixture 15 for securing the guide portion 17 (not shown) to the footrest section 4. The guide portion 17 (not shown) has guide holes 17a (not shown), and the guide rails 4c of the footrest section 4 are slidably inserted into the guide holes 17a. Hence, the guide portion 17 (not shown) is movable along the guide rails 4c in the front-rear direction. Hence, the outer frame 10 can be moved in the front-rear direction of the footrest section 4.

The outer frame 10 of the arm massage machine 7 shown in FIG. 2 has a structure in which the drive chamber 13 for accommodating the drive unit 28 is provided in the bottom portion 11a and the left and right side portions 11b, and the drive force is applied from both the left and right sides to the respective support plates 22 and the air cells 23a and 23b; on the other hand, the outer frame 10 of the leg massage machine 6 shown in FIG. 6 has a structure in which the drive chamber 13 for accommodating the drive unit 28 is provided in the bottom portion 11a, the side portion 11b and the upper portion 11d, and the drive force is applied from both the upper and lower sides to the respective support plates 22 and the air cells 23a and 23b. Since the outer frame 10 does not differ from that of the arm massage machine 7 shown in FIG. 2 in other respects, the detailed description thereof is omitted.

The right leg massage machine 6 has been described in FIG. 6; since the left leg massage machine 6 has the same configuration as that of the right leg massage machine 6, except that the respective components thereof are just opposite in the left-right direction, the detailed description thereof is omitted.

FIG. 7 shows an example of a control circuit 30 provided for the leg massage machines 6 and the arm massage machines 7. As shown in FIG. 7, the control circuit 30 includes a control portion 31, a remote controller 32, the drive units 28, solenoid valves 35, the air supplying/exhausting apparatus 36, and the air cells 23a and 23b.

Each of the solenoid valves 35 is provided for each pair of the air cells 23a and 23b of the left and right leg massage machines 6 and the left and right arm massage machines 7 so that the respective solenoid valves can perform air supply and exhaust independently.

As described above, in the massage machine according to the first embodiment, the pair of air cells disposed opposite to each other holds a treatment site therebetween in the up-down direction or in the left-right direction, and the pair of air cells can be reciprocated together. Hence, the treatment site can be stroked on both sides in the up-down direction or in the left-right direction, whereby stroke massage can be performed efficiently.

In addition, the pair of air cells can hold the treatment site therebetween in the up-down direction or the left-right direction by the expandable/contractible biasing portions and can make contact with the treatment site at all times. Hence, the pair of air cells can stroke the treatment site at all times by applying the constant pressing stimulus thereto from both sides in the up-down direction or in the left-right direction, whereby the user can get a favorable stroke massage effect.

Furthermore, since the biasing portions cause the pair of air cells to approach each other when the massage machine is used, the opposed distance between the pair of air cells in a state that the massage machine is not used can be set wider as compared with the case that the biasing portions are not provided.

As a result, when the massage machine is used, the treatment site can be easily inserted into or withdrawn from between the pair of air cells.

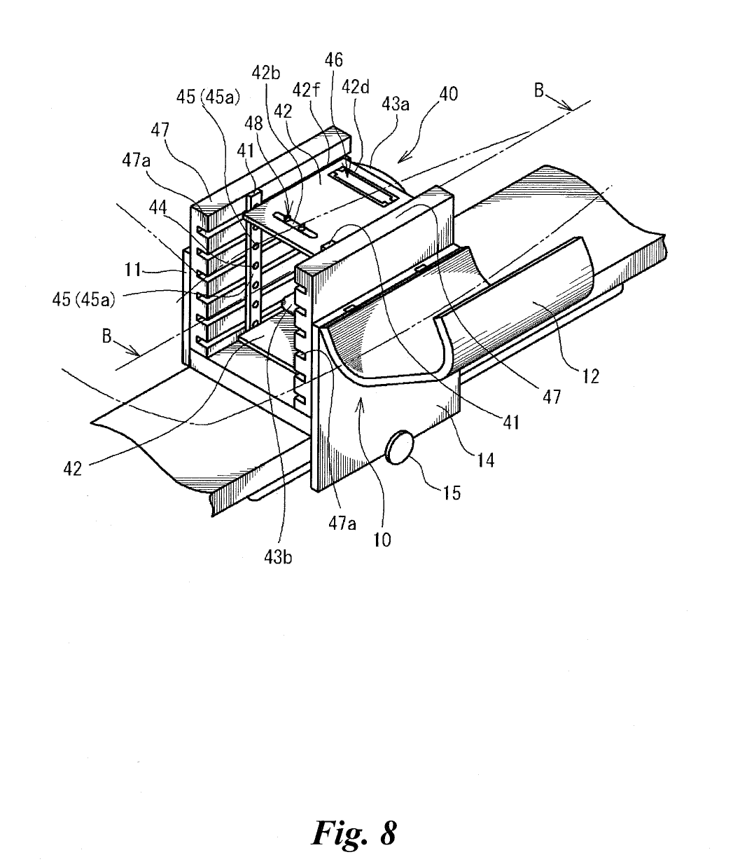

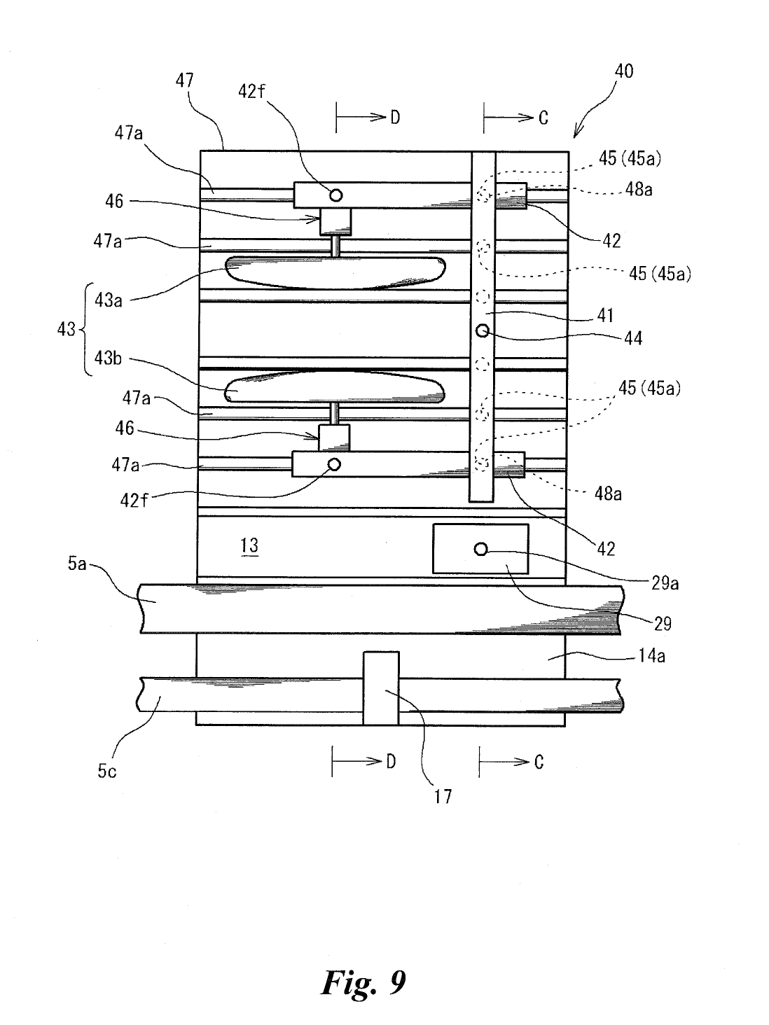

FIGS. 8 to 11 show a second embodiment of a massage machine according to the present invention. The right arm massage machine 7 shown in FIGS. 8 to 11 is equipped with a massaging mechanism 40 having a link mechanism, such as a mechanism for adjusting the opposed distance between a pair of support plates, different from the above-mentioned massaging mechanism 20.

This massaging mechanism 40 is equipped with a pair of treatment devices 43 disposed opposite to each other at a given distance therebetween in the up-down direction, a pair of support plates (a first support: a support member) 42 for supporting the pair of treatment devices 43 from the outside in the up-down direction, a distance adjustment portion 48 for adjusting the opposed distance between the pair of support plates 42, a pair of rotation portions (a second support: a support member) 41 for applying a drive force to the pair of support plates 42 in the front-rear direction (the second direction) and for supporting the support plates 42 on both the left and right sides, guide portions 45 formed in the pair of rotation portions 41 to support the pair of support plates 42 so that the pair of support plates 42 is movable in a direction (the first direction) in which the support plates 42 approach and separate from each other, biasing portions 46, supported on the pair of the support plates 42, for biasing the pair of treatment devices 43 in a direction in which the treatment devices approach each other, movement restriction portions 47, provided on the left and right outsides of the pair of rotation portions 41, for reciprocating the pair of support plates 42 while maintaining a constant distance therebetween, rotation shafts 44 provided in the pair of rotation portions 41, and a drive unit 28 for applying a rotation drive force to the rotation shafts 44.

Each of the treatment devices 43 is formed of a plate member having elasticity and has a treatment device (a first pressing member) 43a for pressing a treatment-site arm from above and a treatment device (a second pressing member) 43b for pressing the arm from below. When the treatment devices 43a and 43b hold the arm therebetween in the up-down direction, the opposed faces of the treatment devices 43 are deformed elastically by the reaction from the arm. In this way, the treatment devices 43 can be made contact with the arm along the contour thereof.

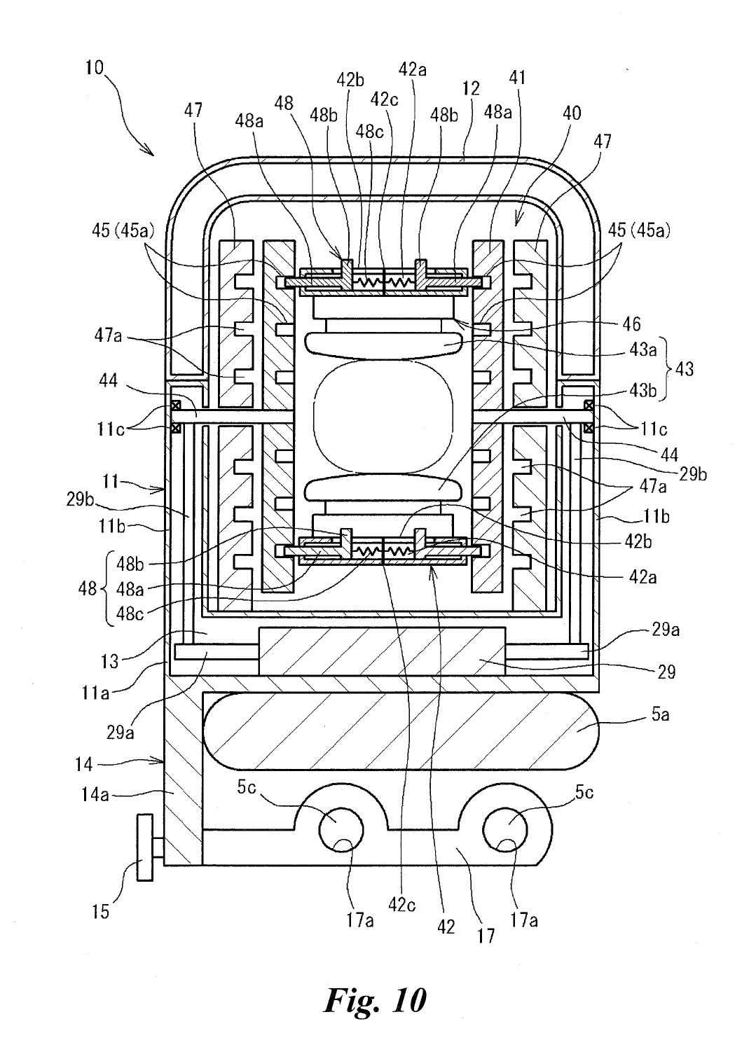

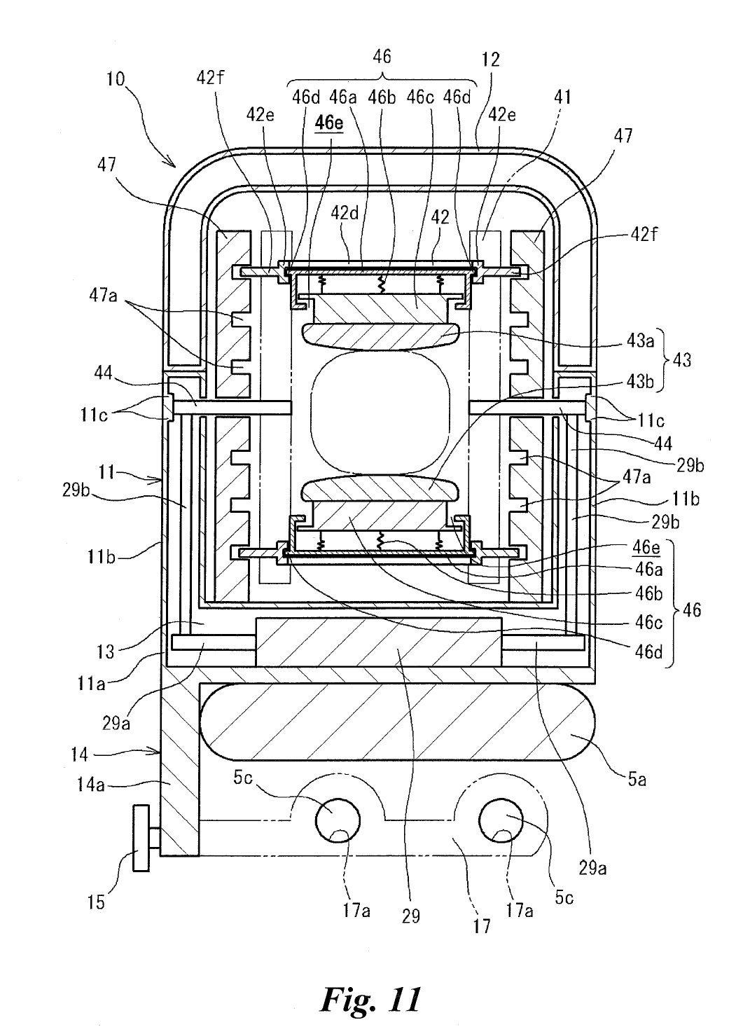

Each of the support plates 42 is equipped with an accommodation portion 42a (see FIG. 10) formed in the rear inside portion thereof to accommodate the distance adjustment portion 48, an opening portion 42b (see FIG. 10) being open in the upper portion of the accommodation portion 42a and having a given length, left and right through holes (not shown) passing through from both the left and right side faces to the accommodation portion 42a, a partition plate 42c (see FIG. 10) provided at the center portion of the accommodation portion 42a, a square hole 42d having a rectangular shape (see FIG. 11) passing through the upper and lower faces at the front portion, support concave portions 42e (see FIG. 11), formed on both the left and right sides of the inner face on the side of the square hole 42d of the support plate 42, for supporting the biasing portion 46, and restriction shafts 42f (see FIG. 11) protruding from both the left and right end portions of the front portion to restrict up/down movement during reciprocation movement.

The distance adjustment portion 48 has left and right shaft portions 48a, knobs 48b each protruding upward from one end portion of the shaft portion 48a, and springs 48c for biasing the shaft portions 48a in the left-right direction as shown in FIG. 10. The respective shaft portions 48a are accommodated in the accommodation portion 42a in a state in which the knobs 48b, each provided at one end of each of the shaft portions 48a, are opposed to each other, and the spring 48c is disposed between each of the shaft portions 48a and the partition plate 42c. In addition, the other ends of the shaft portions 48a are inserted into the through holes provided in both the left and right side faces of the support plate 42. Furthermore, the upper portions of the knobs 48b protrude from the opening portion 42b of the accommodation portion 42a.

In this case, since the springs 48c bias the shaft portions 48a outward in the left-right direction, the other ends of the shaft portions 48a protrude outward from the through holes of the support plate 42 and are accommodated in the guide portions 45 of the rotation portions 41. In addition, the other ends of the shaft portions 48a are withdrawn inward by causing the knobs 48b of the shaft portions 48a to approach each other and by contracting the springs 48c, whereby the other ends of the shaft portions 48a are pulled out from the guide portions 45 of the rotation portions 41.

The rotation portions 41 are each formed of a long plate member and have the guide portions 45 on the inside faces thereof opposed to each other. As shown in FIG. 10, the guide portion 45 has a plurality of distance adjustment bearings 45a in the longitudinal direction of the rotation portion 41, and the tip end portions of the shaft portions 48a of the distance adjustment portion 48 are accommodated in the distance adjustment bearings 45a of the rotation portions 41. In this case, the distance adjustment bearings 45a are provided so as to correspond to a plurality of restriction grooves 47a provided in the movement restriction portions 47 described later. For the selection of the distance adjustment bearings 45a, the restriction grooves 47a are selected depending on the size of the treatment-site arm, thereby determining the distance adjustment bearings 45a.

Moreover, the distance adjustment bearing 45a applies a pressing force to the shaft portion 48a in the front-rear direction by the rotation of the rotation portion 41. In other words, a drive force for reciprocating the support plates 42 in the front-rear direction is applied from the guide portions 45.

The biasing portion 46 has an outer frame portion 46a having a nearly rectangular box shape, more than one springs 46b for biasing the treatment device 43 accommodated in the outer frame portion 46a, and a support portion 46c for supporting the treatment device 43 as shown in FIG. 11.

First, the biasing portion 46 supported using the upper support plate 42 will be described.

The outer frame portion 46a has shaft portions 46d protruding to both the left and right end portions of the upper plate portion thereof in the left-right direction and an opening portion 46e provided in the lower plate portion thereof. The upper plate portion of the outer frame portion 46a is inserted into the square hole 42d, and the shaft portions 46d are pivoted in the support concave portions 42e positioned on both the left and right sides of the square hole 42d. Hence, the outer frame portion 46a can rotate in a given range inside the square holes 42d, whereby the orientation of the contact face of the treatment device 43 can be changed along the contour of the treatment-site arm in the front-rear direction.

One end of each spring 46b is secured to the inside of the upper plate portion of the outer frame portion 46a, and the other end is installed on the upper face portion of the support portion 46c. The support portion 46c is formed of a plate member and has flange portions on the upper portion thereof, these flange portions are accommodated in the outer frame portion 46a, and the lower portion protrudes from the opening portion 46e. In this case, the upper portion having the flange portions has an area larger than that of the opening portion 46e, and the upper portion having the flange portions is locked to the outer frame portion 46a at the opening portion 46e, whereby the support portion 46c, being biased by the biasing forces of the springs 46b, is prevented from falling from the outer frame portion 46a. In addition, the springs 46b expand and contract depending on the size of the treatment-site arm, the support portion 46c is biased by the springs 46b, whereby the treatment device 43 supported on the support portion 46c makes contact with the contour of the arm.

Next, the biasing portions 46 supported using the lower support plate 42 will be described. In comparison with the biasing portions 46 supported using the upper support plate 42, the biasing portions 46 supported using the lower support plate 42 have the same structure therewith, except that the orientations thereof in the up-down direction are different. Since the treatment devices 43 are biased by the biasing portions 46 toward the center in the up-down direction as described above, the opposed distance between the treatment devices 43 is adjusted depending on the size of the arm. Furthermore, since the treatment devices 43 are movable outward in the up-down direction by the biasing portions 46 formed of the springs, reciprocation movement can be performed along the contour of the arm, regardless of the size of the arm. Hence, the treatment devices 43 can make contact with the arm at all times and can apply a constant pressing stimulus at all times.

The movement restriction portions 47 have the plurality of restriction grooves 47a in the up-down direction to move the support plates 42 in the front-rear direction, the tip end portions of the left and right restriction shafts 42f of the support plates 42 are accommodated in the restriction grooves 47a, and the left and right restriction shafts 42f are supported to be slidable in the front-rear direction. Furthermore, it is possible to select the restriction grooves 47a depending on the size of the treatment-site arm, whereby the opposed distance between the support plates 42 can be adjusted.

Moreover, since the restriction grooves 47a restrict the up-down direction movement of the restriction shafts 42f, the front portions of the support plates 42 being away from the guide portions 45 are prevented from approaching too close to each other, and the pressing stimulus from the treatment devices 43a and 43b to the arm is prevented from becoming excessively strong. Alternatively, the front portions of the support plates 42 are prevented from separating too far away from each other, and the pressing from the treatment devices 43a and 43b to the arm is prevented from being disabled. A through hole into which the rotation shaft 44 is inserted with a space is provided at the center portion in the front-rear direction and the up-down direction of the movement restriction portion 47.

One end of the rotation shaft 44 is secured to the center portion of the rotation portion 41, and the other end thereof is rotatably supported on the support portion 11c of the accommodation portion 11. In addition, the rotation drive force in the forward-reverse direction of the motor 29 of the drive unit 28 rotates the rotation shafts 44 and the rotation portions 41, thereby reciprocating the support plates 42 and the treatment devices 43. Since the drive unit 28 does not differ from that of the arm massage machine 7 shown in FIGS. 2 to 5B in other respects, the detailed description thereof is omitted.

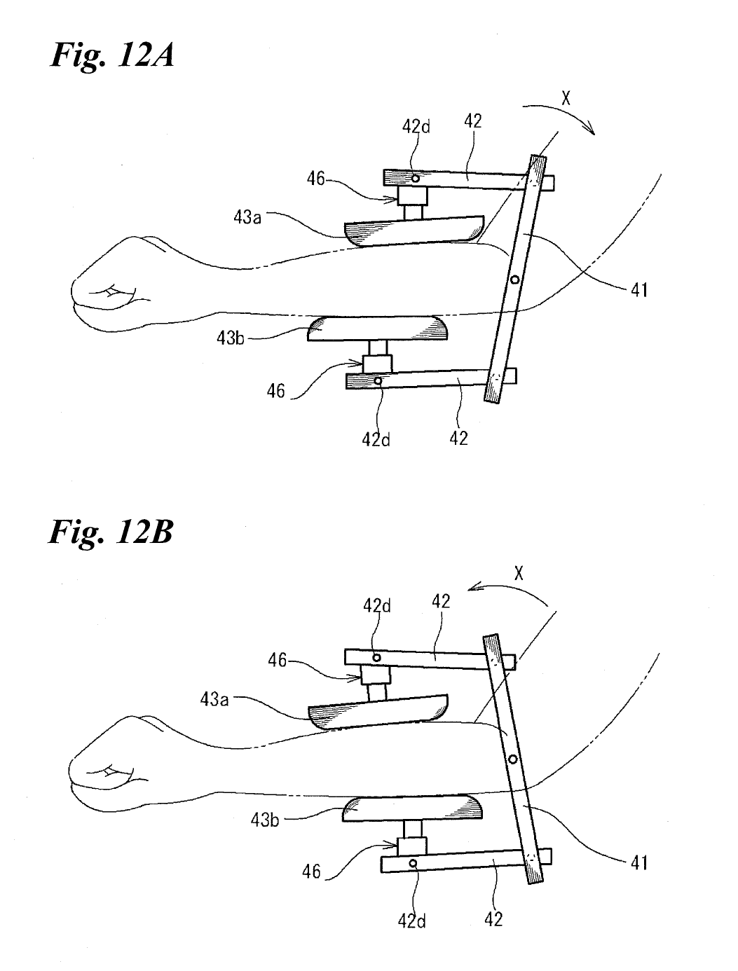

FIGS. 12A and 12B show the stroke massaging motion of the arm massage machine 7 according to the second embodiment. FIG. 12A shows a state in which the rotation portions 41 are rotated backward as indicated by arrow X. In this case, the treatment devices 43a and 43b hold the arm therebetween in the up-down direction by the biasing portions 46, and the treatment devices 43a and 43b make contact with the arm along the contour thereof. At this time, a constant pressing stimulus is applied to the arm in a range contacting with the treatment devices 43a and 43b.

FIG. 12B shows a state in which the rotation portions 41 are rotated forward as indicated by arrow X. Also in this case, the treatment devices 43a and 43b hold the arm therebetween in the up-down direction by the biasing portions 46, and the treatment devices 43a and 43b make contact with the arm along the contour thereof. Furthermore, the constant pressing stimulus is applied to the arm in a range contacting with the treatment devices 43a and 43b.

In addition, the change between the state shown in FIG. 12A and the state shown in FIG. 12B is described; the treatment devices 43a and 43b move along the contour of the arm while being biased by the biasing portions 46. In other words, the treatment devices 43a and 43b make contact with the arm at all times and move to apply the constant pressing stimulus at all times. Hence, the contour of the arm is stroked with the treatment devices 43a and 43b. Furthermore, this movement is repeated to perform a stroke massaging motion.

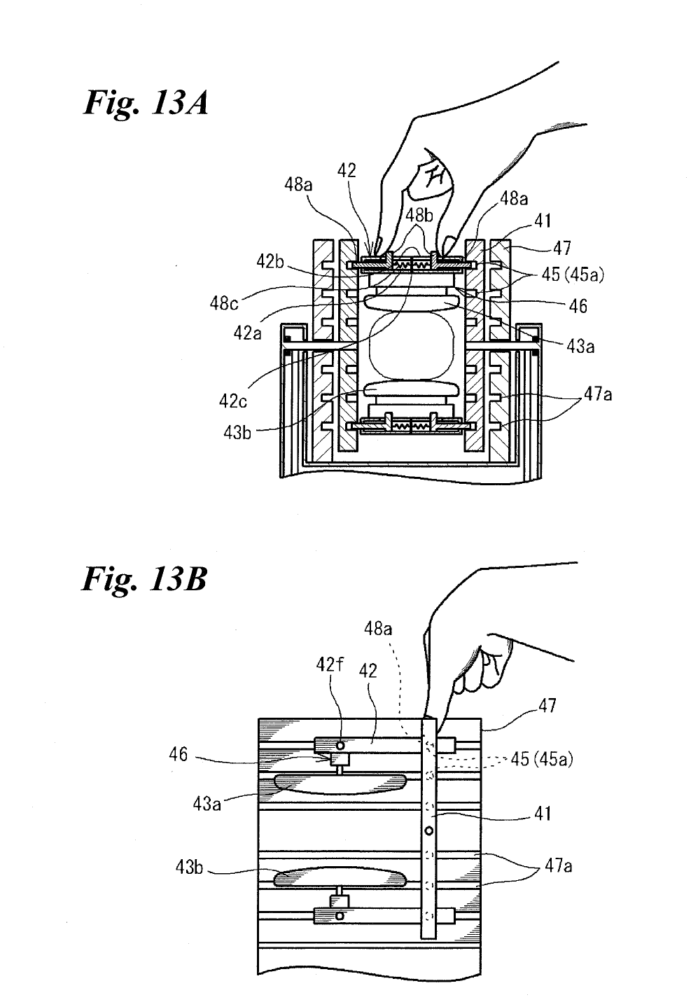

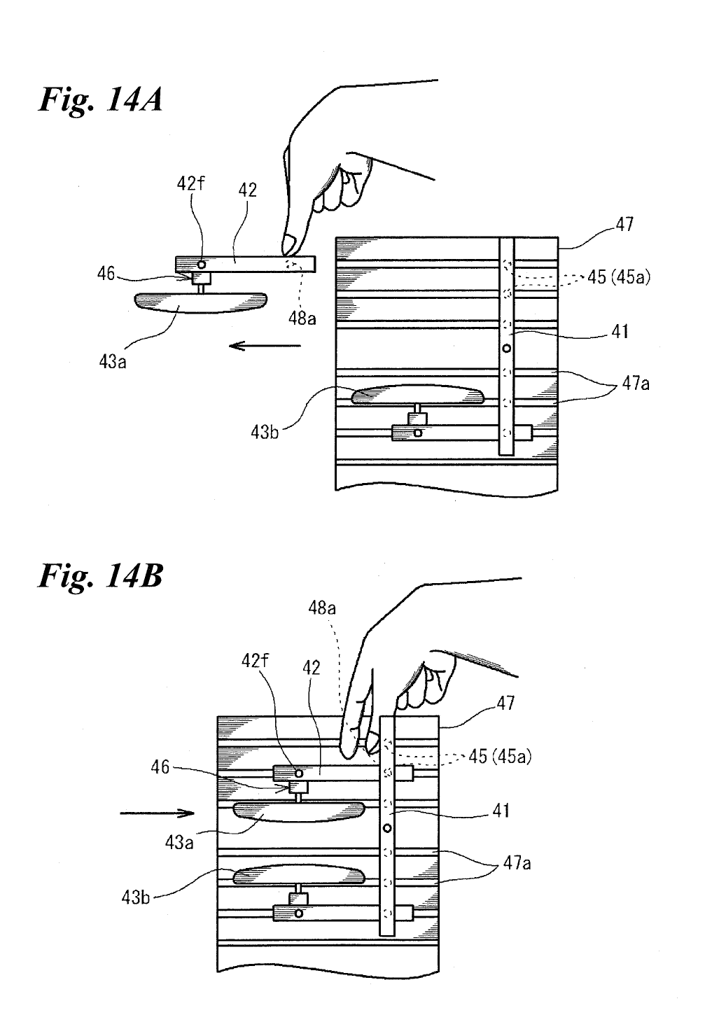

FIGS. 13A to 14B are explanatory views illustrating procedures for adjusting the opposed distance between the treatment devices 43. The procedure for adjusting the opposed distance between the pair of treatment devices 43 of the arm massage machine 7 according to the second embodiment will be described referred to FIGS. 13A to 14B.

First, as shown in FIG. 13A, the cover portion 12 of the arm massage machine 7 is set into an open state. In addition, the knobs 48b of the left and right shaft portions 48a are held between the fingers, thereby moving the knobs 48b close to each other and withdrawing inward the tip end portions of the shaft portions 48a protruding outward from the support plate 42.

Hence, the tip end portions of the shaft portions 48a are withdrawn from the distance adjustment bearings 45a of the guide portions 45 of the rotation portions 41, and the support plate 42 is movable in the front-rear direction, whereby the support plate 42 can be removed.

Next, while the knobs 48b (not shown) are held between the fingers, the support plate 42 is moved forward as shown in FIG. 14A from the state shown in FIG. 13B. Then, as shown in FIG. 14B, the support plate 42 is moved from forward to backward while the positions of the restriction grooves 47a of the movement restriction portions 47 for supporting the restriction shafts 42f of the support plate 42 are changed. At this time, the support plate 42 is moved while the knobs 48b (not shown) are held with the fingers, and the knobs 48b (not shown) are released at the positions of the distance adjustment bearings 45a of the guide portions 45 corresponding to the selected restriction grooves 47a, whereby the tip end portions of the shaft portions 48a are accommodated into the distance adjustment bearings 45a of the guide portions 45. Hence, the support plate 42 is installed in the rotation portions 41.

In this way, the opposed distance between the treatment devices 43 can be adjusted depending on the size of the treatment-site arm. In addition, although the method for adjusting the opposed distance by moving only the upper treatment device 43a of the treatment devices 43 is illustrated in FIGS. 13A to 14B, the opposed distance can also be adjusted by moving the lower treatment device 43b. In this case, the upper treatment device 43a is removed once, and the lower treatment device 43b is moved using the same method as described in the above-mentioned procedure. Since the method does not differ in other respects, the detailed description thereof is omitted.

Since the procedure for adjusting the opposed distance between the treatment devices 43 is performed only by changing the positions of the restriction grooves 47a of the movement restriction portions 47 and the distance adjustment bearings 45a of the guide portions 45, the opposed distance between the treatment devices 43 can be adjusted using a simple structure. Furthermore, the support plate 42 can be removed and installed easily with one hand, thereby being advantageous for easy handling.

The right arm massage machine 7 has been described in FIGS. 8 to 14B; since the left arm massage machine 7 has the same configuration as that of the right arm massage machine 7, except that the respective components thereof are just opposite in the left-right direction, the detailed description thereof is omitted.

Furthermore, the right arm massage machine 7 has the treatment devices 43a and 43b for holding an arm therebetween in the up-down direction; on the other hand, different from the arm massage machine, the left and right leg massage machines 6 each have the treatment devices 43a and 43b for holding a leg therebetween in the left-right direction to perform stroke massage on both the left and right sides of the leg, thereby having a structure of applying a drive force from both the upper and lower sides. Since the basic configurations are the same in other respects, the detailed descriptions thereof are omitted.

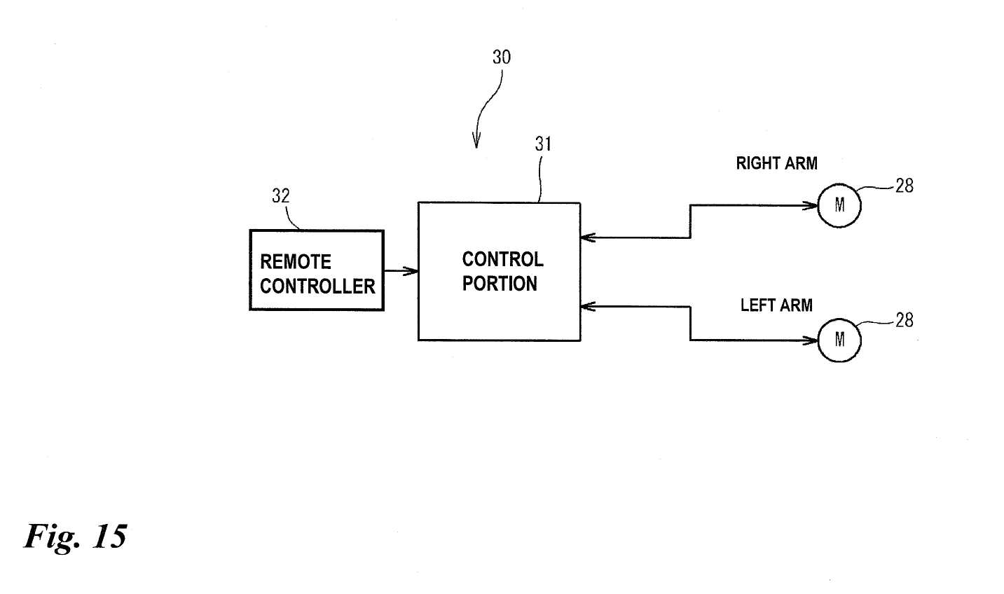

FIG. 15 shows an example of a control circuit 30 provided for the left and right arm massage machines 7 according to the second embodiment. As shown in FIG. 15, the control circuit 30 includes a control portion 31, a remote controller 32, and the drive units 28.

As described above, in the massage machine according to the second embodiment, the pair of treatment devices disposed opposite to each other holds a treatment site therebetween in the up-down direction, and the pair of treatment devices can be reciprocated together. Hence, the treatment site can be stroked on both sides in the up-down direction, whereby stroke massage can be performed efficiently. In addition, the pair of treatment devices can hold the treatment site therebetween in the up-down direction by the expandable/contractible biasing portions and can make contact with the treatment site at all times. Hence, the pair of treatment devices can stroke the treatment site at all times by applying the constant pressing stimulus thereto from both sides in the up-down direction, whereby the user can get a favorable stroke massage effect. Furthermore, the opposed distance between the pair of treatment devices for holding the treatment site therebetween in the up-down direction can be adjusted, and the pair of treatment devices can stroke the treatment site by applying the constant pressing stimulus regardless of the size of the treatment-site arm. For this reason, stroke massage can be performed on the treatment site in a range wider than that in the first embodiment, and the user can get a more favorable stroke massage effect.

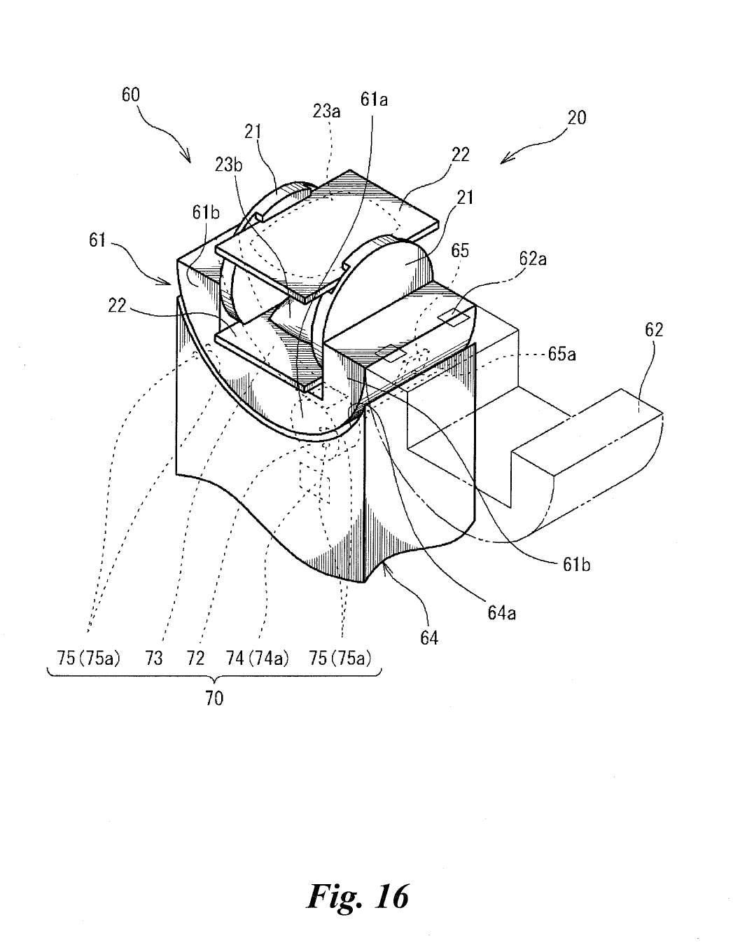

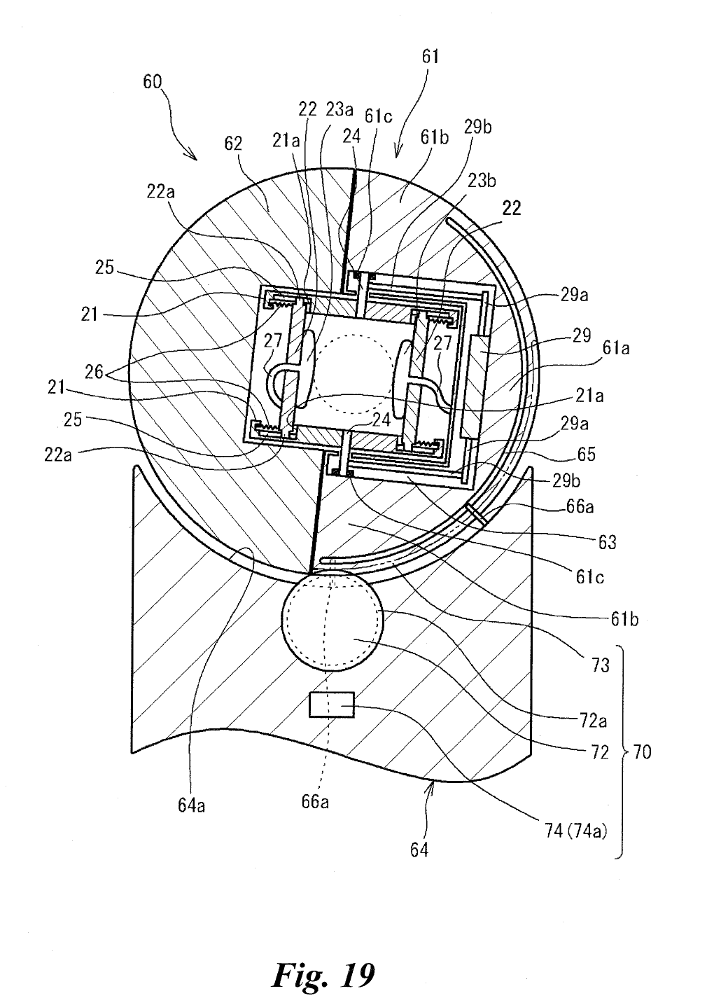

FIGS. 16 to 19 show a third embodiment of a massage machine according to the present invention.

The right arm massage machine 7 shown in FIGS. 16 to 19 is equipped with the above-mentioned massaging mechanism 20, a pressing direction adjustment portion 70 having a gear mechanism for rotating the massaging mechanism 20 in the circumferential direction of a treatment-site arm (for changing the first direction), and an outer frame 60 for accommodating the massaging mechanism 20 and the pressing direction adjustment portion 70 so that the massaging mechanism can rotate in the circumferential direction of the treatment-site arm.

The outer frame 60 has an accommodation portion 61, opened in the upper portion thereof and in the front-rear direction, for accommodating the massaging mechanism 20, a cover portion 62 for covering the accommodation portion 61 and the upper portion of the massaging mechanism 20 accommodated, and an installation portion 64 for accommodating and installing the pressing direction adjustment portion 70 on the armrest section 5.

The accommodation portion 61 has a bottom portion 61a and left and right side portions 61b protruding upward from both the left and right ends of the bottom portion 61a. The continuous outer circumferential surface ranging from this bottom portion 61a to the left and right side portions 61b has a semicircular shape being circular in the lower portion thereof and has a rectangular concave shape at the center portion of this semicircular shape, as viewed from the front. This rectangular concave shape shows a portion enclosed by the bottom portion 61a and the left and right side portions 61b. In other words, the accommodation portion 61 has a semicircular column shape in the front-rear direction and has a concave portion at the center portion of the semicircle of the semicircular column shape, and this concave portion is open in the front-rear direction.

In addition, the bottom portion 61a has a horizontal rectangular-parallelepiped inner space in the lower portion of the concave portion, the left and right side portions 61b each have a vertical rectangular-parallelepiped inner space on each of the left and right sides of the concave portion, the inner space of the bottom portion 61a communicates with the inner spaces of the left and right side portions 61b. The inner space of the bottom portion 61a and the inner spaces of the left and right side portions 61b communicating therewith constitute a drive chamber 63 for accommodating a drive unit 28 for applying a drive force to the massaging mechanism 20. Support portions 61c formed of a bearing are provided in the inner spaces of the left and right side portions 61b. The massaging mechanism 20 is supported using the left and right support portions 61c and accommodated inside the area enclosed by the bottom portion 61a and the left and right side portions 61b.

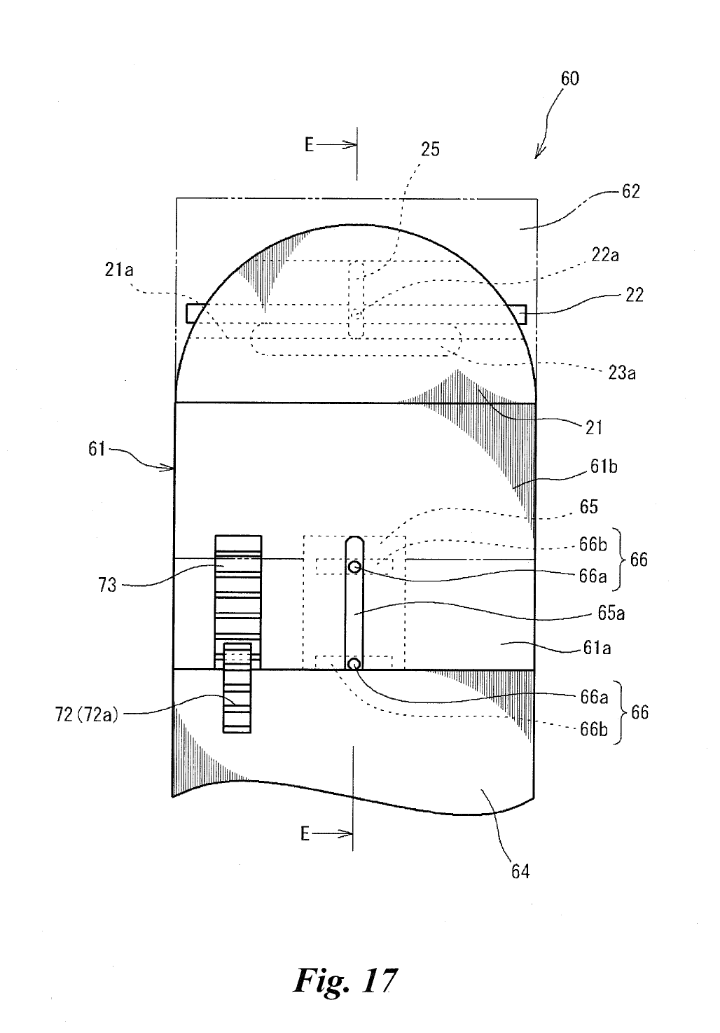

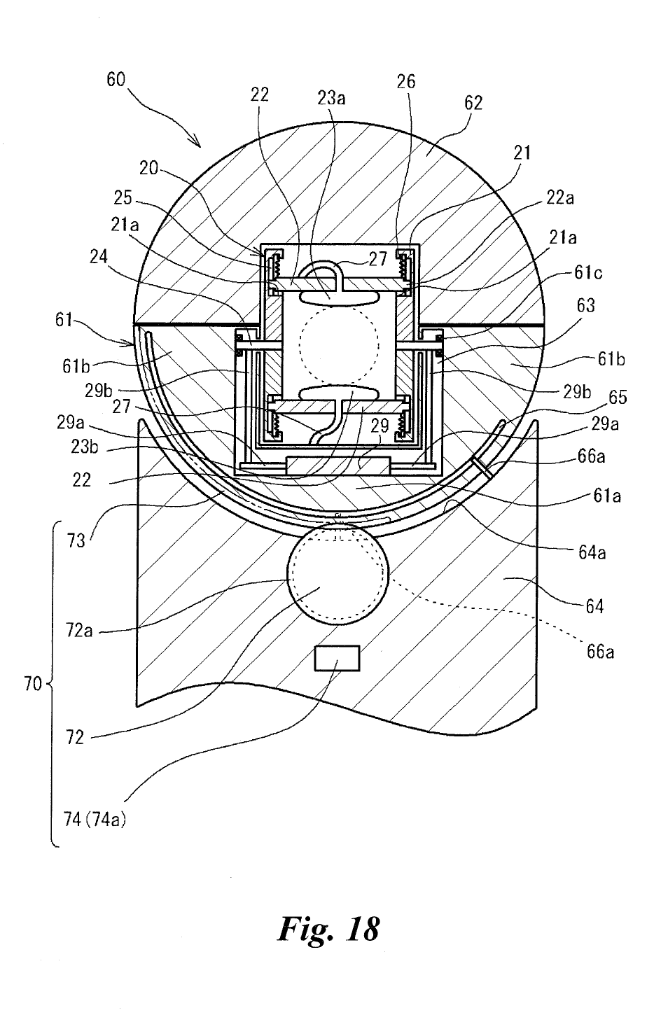

Furthermore, in the outer circumferential portion of the accommodation portion 61, a movement restriction area 65 having a belt-shaped space in the circumferential direction is provided. As shown in FIG. 18, the movement restriction area 65 is formed, on the outer circumferential portion of the accommodation portion 61 at the center portion in the front-rear direction, from a position around the left side end portion to a position opposed to around the right side end portion of the installation portion 64. Moreover, as shown in FIG. 17, the movement restriction area 65 has a hole portion 65a opened along the circumferential direction at the center portion in the width direction of the belt-shaped space, and movement restriction members 66 described later are inserted into the hole portion 65a.

The cover portion 62 has a semicircular column shape in the front-rear direction and has a concave portion at the center portion of the semicircle of the semicircular column shape. The cover portion 62 is connected to the upper face of the left side portion of the accommodation portion 61 via hinges 62a; when the cover portion 62 is closed, it is secured to the accommodation portion 61 using a fastener (not shown). When the cover portion 62 is in the closed state, the accommodation portion 61 and the cover portion 62 are formed into a cylindrical shape in the front-rear direction, and a rectangular-parallelepiped space opened in the front-rear direction is provided at the center portion of the circle of the cylinder.

The installation portion 64 is equipped with a guide portion for allowing the outer frame 60 to move in the front-rear direction of the armrest section 5 and a fastener for securing the outer frame 60 to the armrest section 5, although these are not shown; the installation portion is movably installed in the front-rear direction along the guide rails 5c and secured at a desired position. In addition, the installation portion 64 has an upper face 64a having a concave shape opposed to the outer circumferential surfaces of the accommodation portion 61 and the cover portion 62 and concentric with the circular shape of the outer circumferential surfaces and the movement restriction members 66 standing on the upper face 64a.

The movement restriction members 66 each have a support shaft 66a standing on the upper face 64a and a rod-shaped restriction portion 66b installed at the tip end of the support shaft 66a, and are installed at the center portion and the right end portion of the concave portion in the center portion in the front-rear direction of the upper face 64a. In FIG. 17, the support shafts 66a are indicated by solid lines and the restriction portions 66b are indicated by hidden lines. The support shafts 66a are inserted into the hole portion 65a, and the restriction portions 66b are slidably accommodated in the movement restriction area 65. Hence, the accommodation portion 61 can rotate along the upper face 64a of the installation portion 64 within the movement restriction area 65. Furthermore, the accommodation portion 61 is not only supported using the movement restriction members 66 but also locked in the radial direction.

Next, the above-mentioned massaging mechanism 20 is equipped with a pair of air cells 23 disposed opposite to each other at a given distance therebetween in the up-down direction, a pair of support plates (a first support: a support member) 22 for supporting the pair of air cells 23 from the outside in the up-down direction, a pair of rotation portions (a second support: a support member) 21 for applying a drive force to the pair of support plates 22 in the front-rear direction (the second direction) and for supporting the support plates 22 on both the left and right sides, guide portions 25 formed in the pair of rotation portions 21 to support the pair of support plates 22 so that the pair of support plates 22 is movable in a direction (the first direction) in which the support plates 22 approach and separate from each other, biasing portions 26 for biasing the pair of support plates 22 in a direction in which the support plates approach each other, rotation shafts 24 provided in the pair of rotation portions 21, and a drive unit 28 for applying a rotation drive force to the rotation shafts 24; since the configuration is the same as that of the first embodiment, the detailed description thereof is omitted.

Then, the pressing direction adjustment portion 70 will be described below; the pressing direction adjustment portion 70 is equipped with a pinion 72 installed in the installation portion 64 to rotate the accommodation portion 61 in the circumferential direction (to change the first direction), a gear 73 provided on the outer circumferential surface of the accommodation portion 61 to mesh with the pinion 72, a pressing direction adjustment drive portion 74 for driving the pinion 72, and a detection portion 75 for detecting the rotation position of the accommodation portion 61. The pinion 72 has a gear 72a meshing with the gear 73 on the outer circumferential surface thereof and installed in the front portion and at the center in the left-right direction of the installation portion 64. The most part of the pinion 72 is accommodated inside the installation portion 64, and a part thereof protrudes from the upper face 64a.

The gear 73 is formed into a belt shape in the front portion of the outer circumferential surface of the accommodation portion 61 in the range from around the left side end portion to the center portion. In addition, during the rotation in the circumferential direction of the accommodation portion 61, a state in which the gear 73 meshes with the pinion 72 is maintained.

The pressing direction adjustment drive portion 74 is equipped with a motor 74a having a rotation drive force in forward-reverse direction. This rotation drive force in the forward-reverse direction is transmitted to the pinion 72 via a belt (not shown). Hence, the pinion 72 and the gear 73 are rotated, whereby the accommodation portion 61 can be rotated in the circumferential direction. In this case, the rotation range in the circumferential direction of the accommodation portion 61 is limited to the range in the circumferential direction of the gear 73 formed on the outer circumferential surface of the accommodation portion 61.

As shown in FIG. 16, the detection portion 75 has proximity switches 75a, and the proximity switches 75a are embedded in the accommodation portion 61 and the installation portion 64. In the installation portion 64, the proximity switches 75a are embedded at two positions of the left and right side end portions in the front portion of the upper face 64a. Furthermore, in the accommodation portion 61, the proximity switches 75a are embedded at positions opposed to the proximity switches 75a embedded in the installation portion 64. At this time, the intersection angle formed by the radial straight lines passing through the respective proximity switches 75a embedded in the accommodation portion 61 is set at 90 degrees.

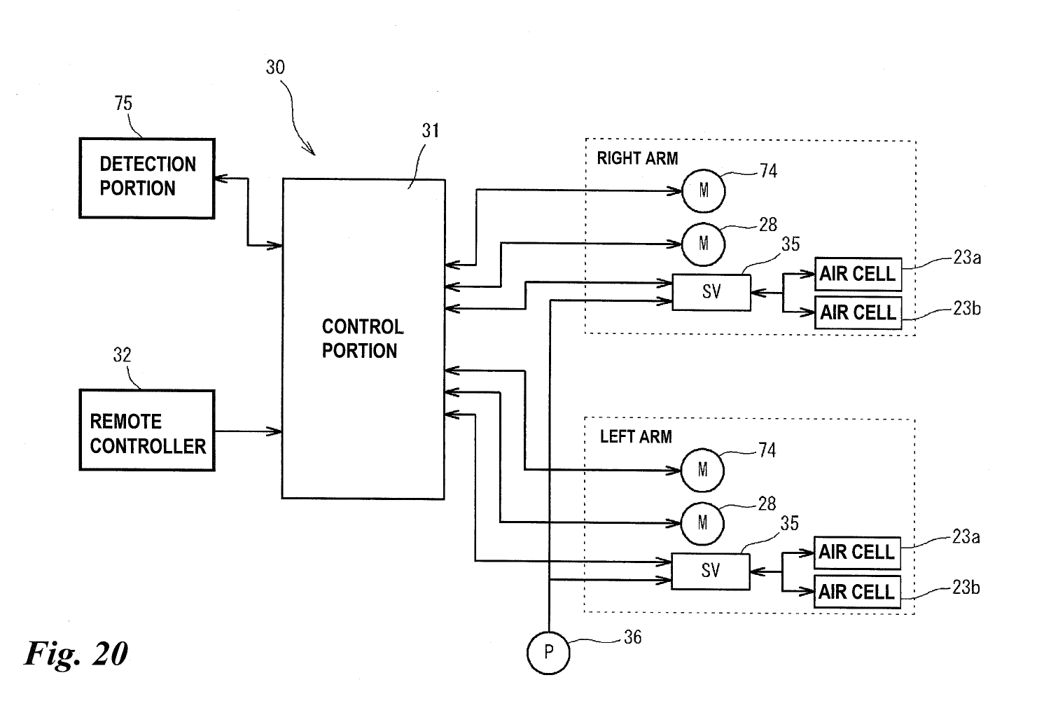

In this case, when one of the proximity switches 75a embedded in the accommodation portion 61 is located at a position opposed to one of the proximity switches 75a embedded in the installation portion 64 in the radial direction by the rotation in the circumferential direction of the accommodation portion 61, the proximity switch 75a detects the rotation position of the accommodation portion 61 and transmits a signal corresponding to the detection result to a control portion 31 (see FIG. 20). In this case, the control portion 31 receives the signal from the proximity switch 75a and converts the direction of the rotation drive force of the pressing direction adjustment drive portion 74 into the reverse direction. Hence, the pinion 72 and the gear 73 are rotated reversely, and the accommodation portion 61 is rotated reversely in the circumferential direction. As a result, the accommodation portion 61 is rotated in the circumferential direction.

The right arm massage machine 7 has been described in FIGS. 16 to 19; since the left arm massage machine 7 has the same configuration as that of the right arm massage machine 7, except that the respective components thereof are just opposite in the left-right direction, the detailed description thereof is omitted. Furthermore, since the left and right leg massage machines 6 are installed not on the armrest main body portions 5a but on the leg placement main body portion 4b, the structure for the installation is different from that of the arm massage machine 7; however, since the basic configurations are the same in other respects, the detailed descriptions thereof are omitted.

FIG. 20 shows an example of a control circuit 30 provided for the left and right arm massage machines 7 according to the third embodiment. As shown in FIG. 20, the control circuit 30 includes the control portion 31, a remote controller 32, the detection portion 75, the drive units 28, the pressing direction adjustment drive portions 74, solenoid valves 35, an air supplying/exhausting apparatus 36, and the air cells 23a and 23b.

Each of the solenoid valves 35 is provided for each pair of the air cells 23a and 23b of the left and right arm massage machines 7 so that the respective solenoid valves can perform air supply and exhaust independently.

As described above, in the arm massage machine according to the third embodiment, the pair of air cells disposed opposite to each other can be rotated in the circumferential direction of a treatment site; hence, the pair of air cells can hold the treatment site therebetween not only in the up-down direction but also in the left-right direction, and can stroke not only the upper and lower regions of the treatment site but also the left and right regions thereof. In this case, since the rotation center of the pair of air cells disposed opposite to each other is located at the center of the treatment site, it is not necessary to move the treatment site, whereby stroke massage can be performed more efficiently. For this reason, stroke massage can be performed on the treatment site in a range wider than that in the first embodiment, and the user can get a more favorable stroke massage effect.

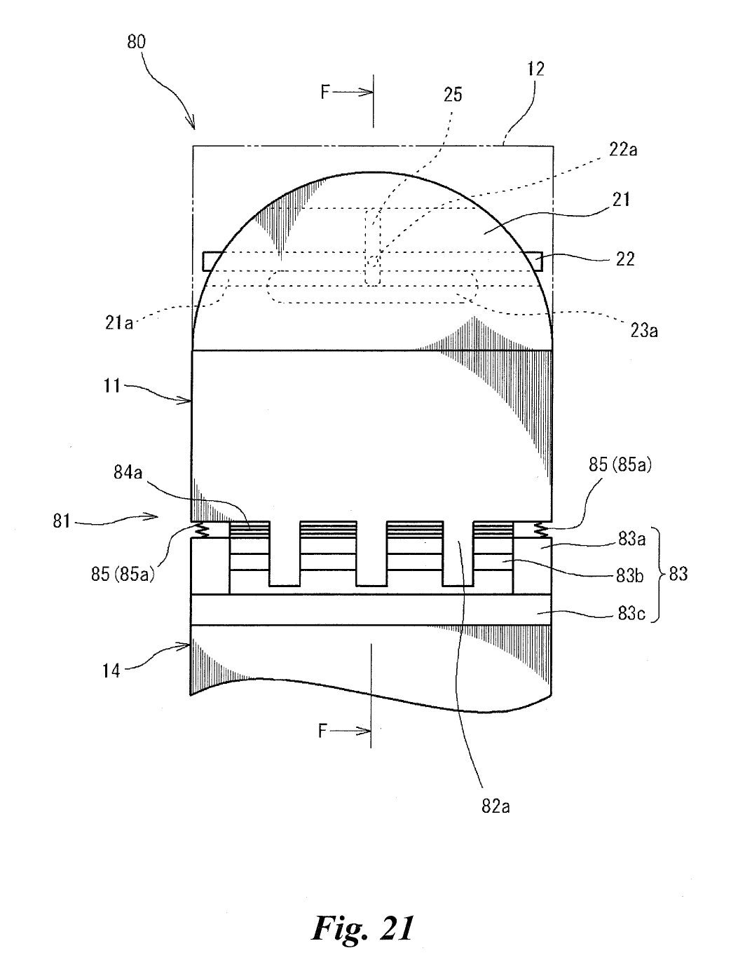

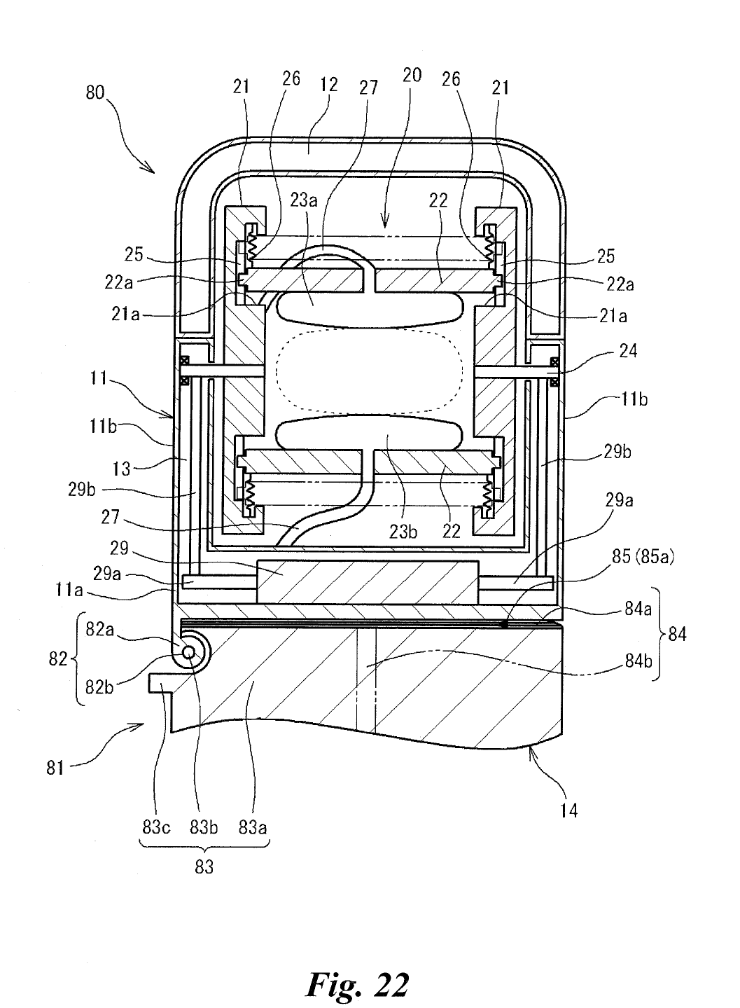

FIGS. 21 to 23 show a fourth embodiment of a massage machine according to the present invention.

The right arm massage machine 7 shown in FIGS. 21 to 23 is equipped with the above-mentioned massaging mechanism 20 and an outer frame 80 in which, for example, a rotation mechanism for overturning the massaging mechanism 20 (for changing the first direction) is further provided in the outer frame 10; by this rotation mechanism, the treatment site can be held in the left-right direction, and stroke massage can be performed on both the left and right sides of the treatment site.

The outer frame 80 is equipped with the outer frame 10 and a pressing direction adjustment portion 81 having the rotation mechanism for overturning the massaging mechanism 20 (for changing the first direction). The outer frame 10 has an accommodation portion 11, opened in the upper portion thereof, for accommodating the massaging mechanism 20, a cover portion 12 for covering the upper portions of the accommodation portion 11 and the massaging mechanism 20 accommodated, and an installation portion 14 for installation on the armrest section 5; and the pressing direction adjustment portion 81 is provided at the accommodation portion 11 and the installation portion 14.

Furthermore, the accommodation portion 11, the cover portion 12 and the massaging mechanism 20 accommodated in the accommodation portion 11 can be rotated sideways by the pressing direction adjustment portion 81.

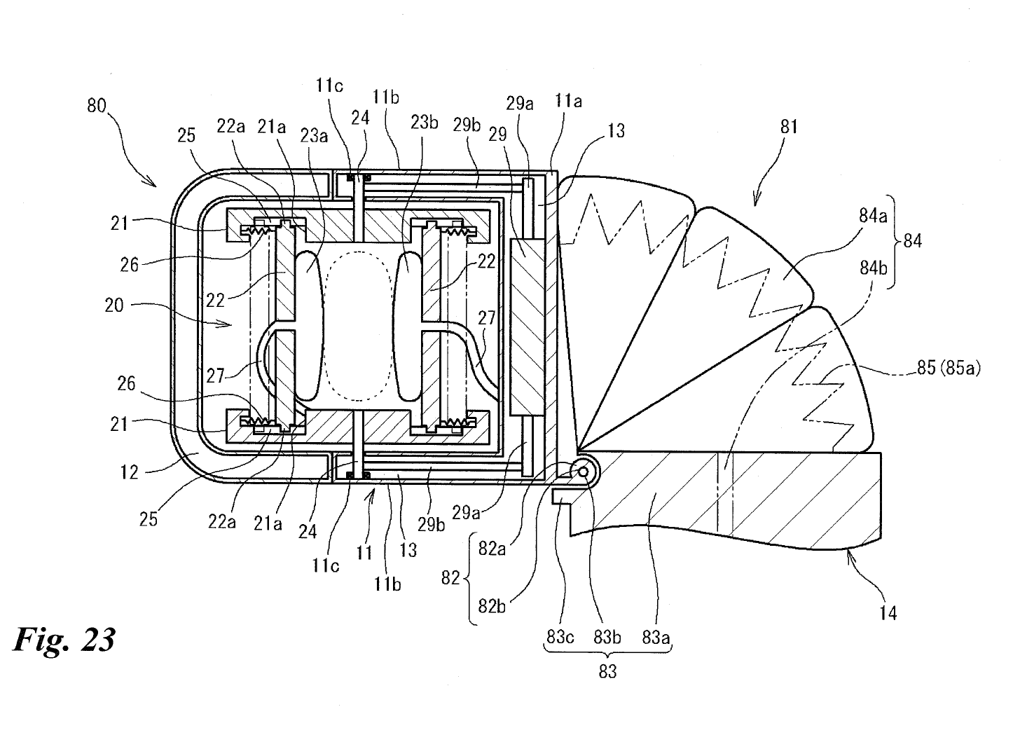

In other words, although the accommodation portion 11 and the installation portion 14 according to the first embodiment are integrated, the accommodation portion 11 and the installation portion 14 according to the fourth embodiment are separated and connected via the pressing direction adjustment portions 81 as shown in FIGS. 21 and 23. Since the configuration is the same as that of the first embodiment in other respects, the detailed description thereof is omitted.

The pressing direction adjustment portion 81 has a rotation portion 82 protruding downward from the left end portion of the bottom portion 11a of the accommodation portion 11, a rotation support portion 83 provided in the upper portion of the installation portion 64 to support the rotation portion 82 so that the rotation portion is rotatable in a given range, an pressing direction adjustment drive portion 84 for applying a drive force for rotating the accommodation portion 11 leftward, and a returning member 85 for returning the accommodation portion 11 to the state before the rotation.

The rotation portion 82 has a circular protrusion portion 82a, and a hole portion 82b is formed in the protrusion portion 82a, as viewed from the front.

The rotation support portion 83 has a rotation base 83a having a concave portion that has a nearly semicircular shape opened on the left side and extending in the front-rear direction as viewed from the front, a rotation shaft 83b installed in the rotation base 83a and disposed in the concave portion in the front-rear direction, and a locking portion 83c provided at the left side end portion below the rotation shaft 83b. The rotation shaft 83b is rotatably inserted into the hole portion 82b of the rotation portion 82.

The locking portion 83c has a protrusion portion formed by protruding the left side end portion of the rotation support portion 83 in the horizontal direction. Hence, when the rotation portion 82 is rotated counterclockwise, the locking portion 83c makes contact with the rotation portion 82. In other words, the rotation of the rotation portion 82 is stopped by the locking portion 83c. In addition, the locking portion 83c can support the rotation portion 82 while being in contact therewith.

The pressing direction adjustment drive portion 84 has a bellows-shaped air cell 84a and an air tube 84b for supplying/exhausting air. One end of the bellows-shaped air cell 84a is connected to the bottom portion 11a of the accommodation portion 11, and the other end is connected to the rotation base 83a of the rotation support portion 83. The air cell 84a expands into a fan shape while the left side end portion thereof is used as a fulcrum by supplying air to the air cell 84a. Hence, the right side end portion of the bottom portion 11a of the accommodation portion 11 is pushed up, and the accommodation portion 11 and the massaging mechanism 20 are rotated leftward. After the air is exhausted, the air cell 84a contracts and becomes a thinly folded state.

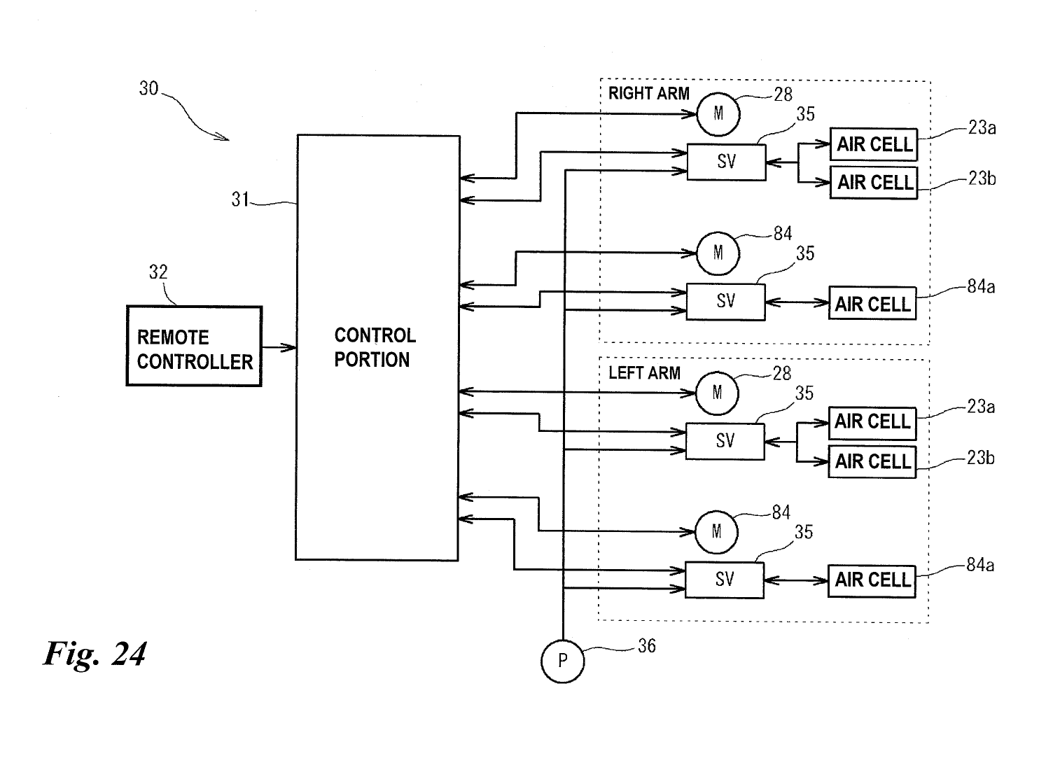

The air tube 84b is inserted into a hole portion (not shown) in the rotation base 83a and routed (not shown) from the installation portion 14 to the area below the armrest section 5 and connected to an air supplying/exhausting apparatus 36 (see FIG. 24) disposed below the seat section 2.

The returning member 85 has springs 85a in front of and behind the air cell 84a in the front-rear direction, and one end of each of the springs 85a is connected to the bottom portion 11a of the accommodation portion 11 and the other end is connected to the rotation base 83a of the rotation support portion 83.

When the accommodation portion 11 and the massaging mechanism 20 are rotated leftward by supplying air to the air cell 84a, the rotation is stopped by the locking portion 83c, and the accommodation portion 11 and the massaging mechanism 20 are supported using the locking portion 83c in the overturned states. Furthermore, when the air of the air cell 84a is exhausted, the accommodation portion 11 and the massaging mechanism 20 are returned by the contracting air cell 84a and the springs 85a of the returning member 85 to the states obtained before the air is supplied to the air cell 84a.

Next, the massaging mechanism 20 is equipped with a pair of air cells 23 disposed opposite to each other at a given distance therebetween in the up-down direction, a pair of support plates (a first support: a support member) 22 for supporting the pair of air cells 23 from the outside in the up-down direction, a pair of rotation portions (a second support: a support member) 21 for applying a drive force to the pair of support plates 22 in the front-rear direction (the second direction) and for supporting the support plates 22 on both the left and right sides, guide portions 25 formed in the pair of rotation portions 21 to support the pair of support plates 22 so that the pair of support plates 22 is movable in a direction (the first direction) in which the support plates 22 approach and separate from each other, biasing portions 26 for biasing the pair of support plates 22 in a direction in which the support plates approach each other, rotation shafts 24 provided in the pair of rotation portions 21, and a drive unit 28 for applying a rotation drive force to the rotation shafts 24; since the configuration is the same as that of the first embodiment, the detailed description thereof is omitted.

In this case, the massaging mechanism 20 can perform massage without problems even in the overturned state. Furthermore, in the arm massage machine 7 according to the third embodiment shown in FIGS. 16 to 19, since the massaging mechanism 20 rotates around a treatment-site arm, it is not necessary to move the arm; on the other hand, in the arm massage machine 7 shown in FIGS. 21 to 23, since the massaging mechanism 20 is overturned, the massaging mechanism 20 is moved sideways. Hence, it is necessary to move the arm in accordance with the movement amount of the massaging mechanism 20.

The right arm massage machine 7 has been described in FIGS. 21 to 23; since the left arm massage machine 7 has the same configuration as that of the right arm massage machine 7, except that the respective components thereof are just opposite in the left-right direction, the detailed description thereof is omitted. Furthermore, since the left and right leg massage machines 6 are installed not on the armrest main body portions 5a but on the leg placement main body portion 4b, the structure for the installation is different from that of the arm massage machine 7; however, since the basic configurations are the same in other respects, the detailed descriptions thereof are omitted.

FIG. 24 shows an example of a control circuit 30 provided for the left and right arm massage machines 7 according to the fourth embodiment. As shown in FIG. 24, the control circuit 30 includes a control portion 31, a remote controller 32, the drive units 28, the pressing direction adjustment drive portions 84, solenoid valves 35, an air supplying/exhausting apparatus 36, the air cells 23a and 23b, and the air cell 84a.

Each of the solenoid valves 35 is provided for each pair of the air cells 23a and 23b and each of the air cells 84a of the left and right arm massage machines 7 so that the respective solenoid valves can perform air supply and exhaust independently.

As described above, in the arm massage machine according to the fourth embodiment, the pair of air cells disposed opposite to each other can hold the treatment site therebetween not only in the up-down direction but also in the left-right direction, and can stroke not only the upper and lower regions of the treatment site but also the left and right regions thereof. For this reason, stroke massage can be performed on the treatment site in a range wider than that in the first embodiment, and the user can get a more favorable stroke massage effect.

Moreover, since the pressing direction adjustment portion according to the fourth embodiment has the rotation mechanism having the bellows-shaped air cell, the treatment site to be massaged can be changed using a simple structure in comparison with the gear mechanism adopted for the pressing direction adjustment portion according to the third embodiment.

On the other hand, in the rotation mechanism according to the fourth embodiment, since the rotation center of the pair of air cells disposed opposite to each other is positioned outside the treatment site, the rotation is associated with the movement of the treatment site.

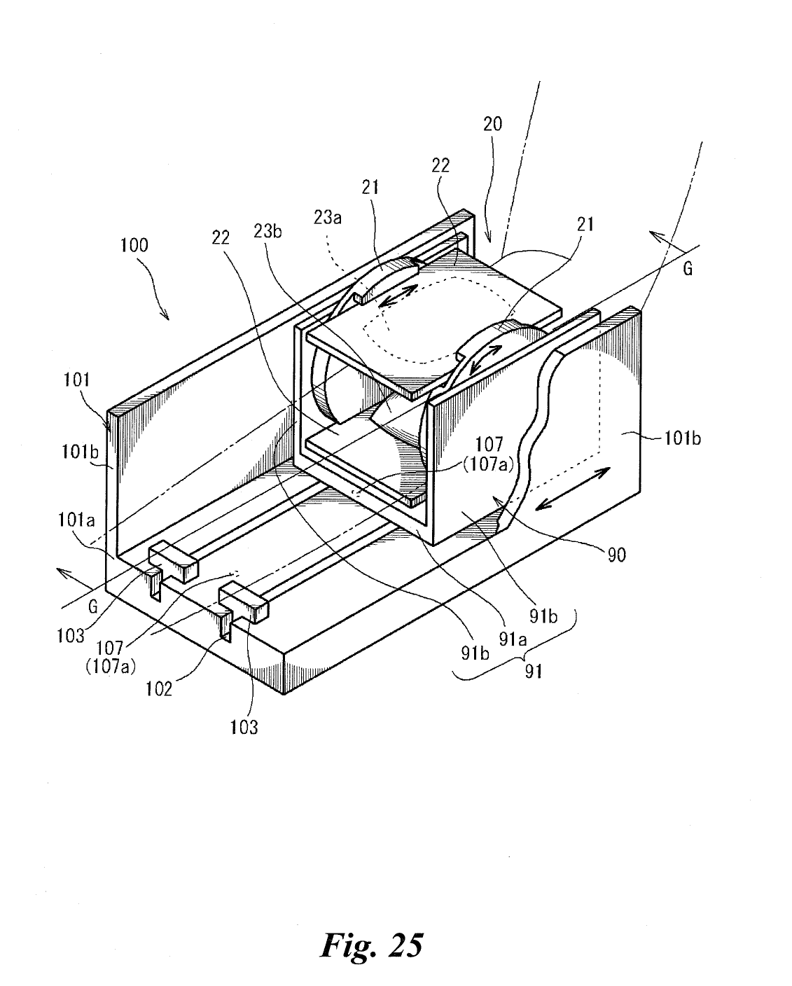

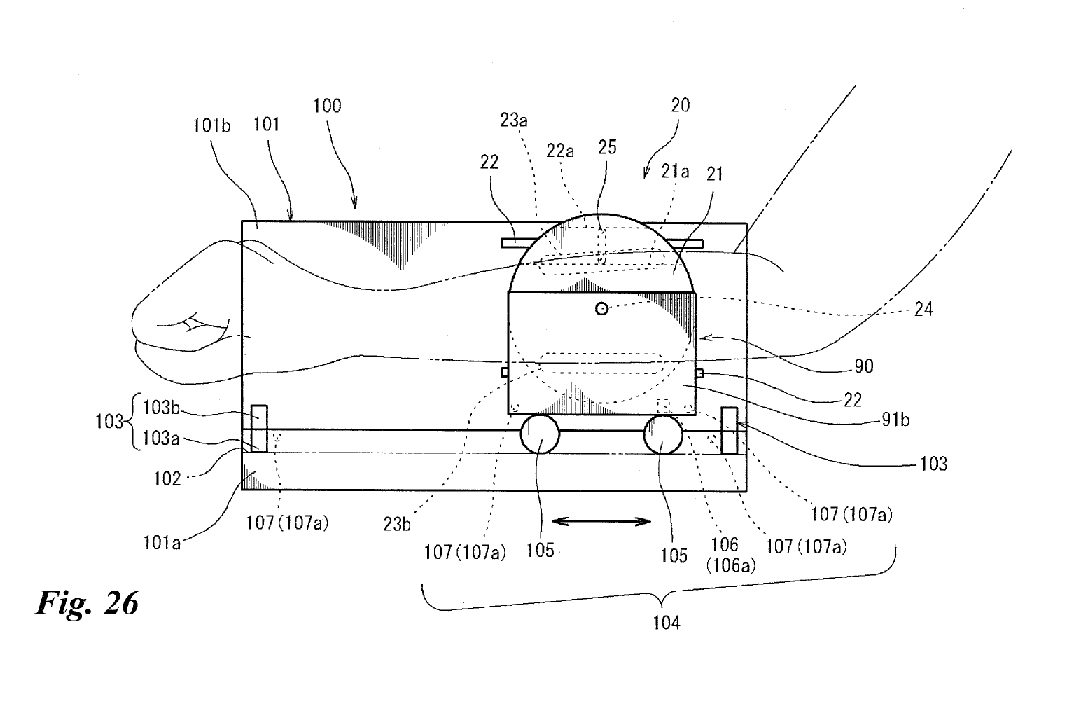

FIGS. 25 and 26 show a fifth embodiment of a massage machine according to the present invention.

The right arm massage machine 7 shown in FIGS. 25 and 26 is equipped with the above-mentioned massaging mechanism 20, an outer frame 90 accommodating the massaging mechanism 20 and being movable (for changing the position in the second direction) in the front-rear direction, that is, in the longitudinal direction of an arm, and a stroke range adjustment portion 100 for moving the outer frame 90 to change the stroke position.

The outer frame 90 has an accommodation portion 91, opened in the upper portion thereof in the front-rear direction, for accommodating the massaging mechanism 20, and a cover portion (not shown) for covering the upper portions of the accommodation portion 91 and the massaging mechanism 20 accommodated.

The accommodation portion 91 has a bottom portion 91a installed on the armrest main body portion 5a and left and right side portions 91b protruding upward from both the left and right ends of the bottom portion 91a. The bottom portion 91a has a space therein and the left and right side portions 91b each have a space therein, and the inner space of the bottom portion 91a communicates with the inner spaces of the left and right side portions 91b. The inner space of the bottom portion 91a and the inner spaces of the left and right side portions 91b communicating therewith constitute a drive chamber 93 for accommodating a drive unit 28 for applying a drive force to the massaging mechanism 20 and the position changing drive portion 106 of a movement mechanism 104 described later. Inside the inner spaces of the left and right side portions 91b, support portions 91c formed of a bearing are provided. The massaging mechanism 20 is supported on the left and right support portions 91c and accommodated inside the area enclosed by the bottom portion 91a and the left and right side portions 91b. The cover portion (not shown) is connected to the upper face of the accommodation portion 91 via hinges.

The stroke range adjustment portion 100 is equipped with a guide portion 101 installed on the armrest main body portion 5a, guide grooves 102 for guiding the front-rear direction movement of the accommodation portion 91, locking portions 103 for restricting the front-rear direction movement of the accommodation portion 91 within a given range, and the movement mechanism 104 for moving the accommodation portion 91 and the massaging mechanism 20 in the front-rear direction (for changing the position in the second direction).

The guide portion 101 has a bottom portion 101a and left and right side portions 101b protruding upward from both the left and right ends of the bottom portion 101a. The guide portion 101 having a length nearly equal to the length of the armrest section 5 in the front-rear direction is installed on the armrest main body portion 5a using an installation portion (not shown) provided for the bottom portion 101a. The accommodation portion 91 is accommodated inside the area enclosed by the bottom portion 101a and the left and right side portions 101b so as to be movable in the front-rear direction.

The guide grooves 102 extending in the front-rear direction are formed on the upper face of the bottom portion 101a.

The locking portion 103 has a support shaft 103a at the lower portion and a protrusion portion 103b at the upper portion and is disposed at both end portions in the front-rear direction of the guide groove 102. The support shaft 103a is inserted into the guide groove 102, the protrusion portion 103b protrudes from the guide groove 102, and the support shaft 103a is secured to the guide groove 102. Furthermore, even if the change of the movement direction of the accommodation portion 91 by means of a detection portion 107 described later cannot be performed, the movement of the accommodation portion 91 can be stopped by making the protrusion portion 103b of the locking portions 103 into contact with the accommodation portion 91.

The movement mechanism 104 is equipped with rollers 105 rotatably installed on the bottom portion 91a of the accommodation portion 91, the position changing drive portion 106 for applying a rotation drive force to the rollers 105, and the detection portion 107 for detecting the movement direction of the accommodation portion 91. The rollers 105 are respectively installed on the left and right sides and at the front and rear positions of the bottom portion 91a of the accommodation portion 91 and are fitted in the guide grooves 102.

The position changing drive portion 106 is equipped with a motor 106a having a rotation drive force in the forward-reverse direction and is accommodated in the drive chamber 93. This rotation drive force in the forward-reverse direction is transmitted to the rollers 105 via belts (not shown). Hence, the rollers 105 rotate and move along the guide grooves 102 in the front-rear direction, whereby the accommodation portion 91 can be moved in the front-rear direction.

The detection portion 107 has proximity switches 107a, and the proximity switches 107a are respectively embedded in both the end portions in the front-rear direction of the bottom portion 91a of the accommodation portion 91 and both the end portions in the front-rear direction of the bottom portion 101a of the guide portion 101 at positions closer to the center from the positions of the locking portions 103. In addition, when the accommodation portion 91 has moved and reached both the end portions in the front-rear direction of the guide portion 101, the proximity switches 107a of the accommodation portion 91 become opposed to the proximity switches 107a of the guide portion 101 in the up-down direction.

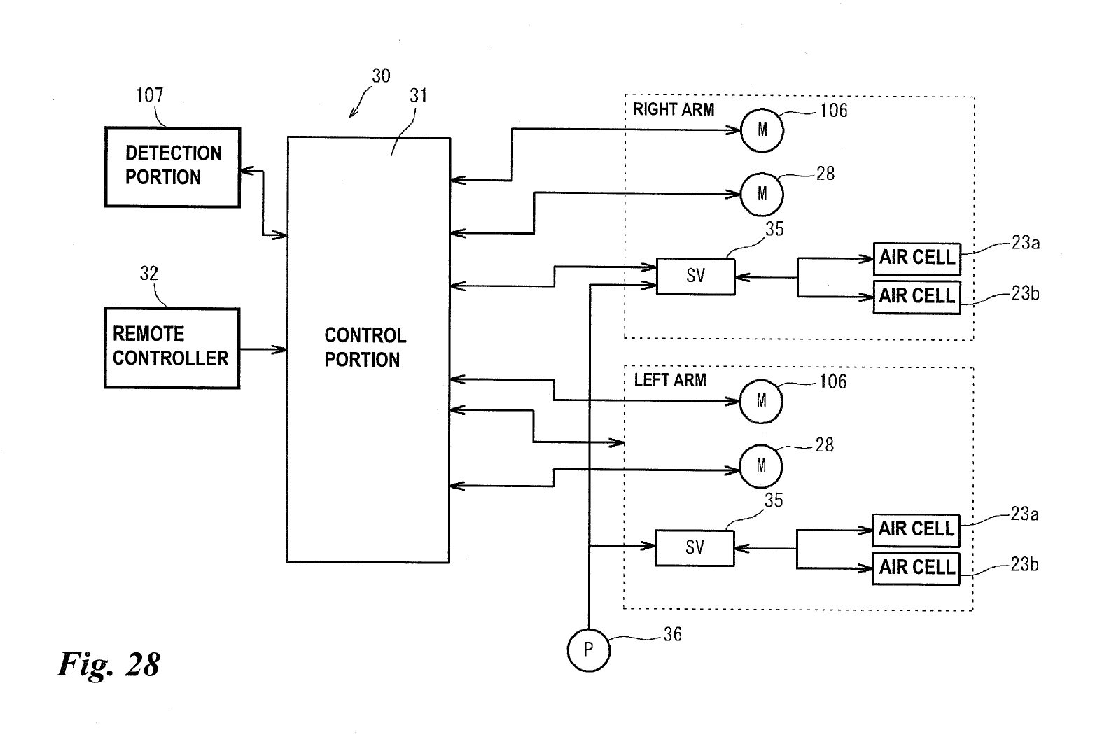

In this case, when the proximity switches 107a of the accommodation portion 91 become opposed to the proximity switches 107a of the stroke range adjustment portion 100 in the up-down direction by the movement of the accommodation portion 91, the proximity switches 107a detect the position of the accommodation portion 91 and transmit a signal corresponding to the detection result to a control portion (see FIG. 28). The control portion 31 receives the signal from the proximity switches 107a and converts the direction of the rotation drive force of the position changing drive portion 106 into the reverse direction. Hence, the rollers 105 are rotated reversely, and the accommodation portion 91 is moved in the reverse direction. As a result, the accommodation portion 91 is moved in the front-rear direction.

Next, the massaging mechanism 20 is equipped with a pair of air cells 23 disposed opposite to each other at a given distance therebetween in the up-down direction, a pair of support plates (a first support: a support member) 22 for supporting the pair of air cells 23 from the outside in the up-down direction, a pair of rotation portions (a second support: a support member) 21 for applying a drive force to the pair of support plates 22 in the front-rear direction (the second direction) and for supporting the support plates 22 on both the left and right sides, guide portions 25 formed in the pair of rotation portions 21 to support the pair of support plates 22 so that the pair of support plates 22 is movable in a direction (the first direction) in which the support plates 22 approach and separate from each other, biasing portions 26 for biasing the pair of support plates 22 in a direction in which the support plates approach each other, rotation shafts 24 provided in the pair of rotation portions 21, and a drive unit 28 for applying a rotation drive force to the rotation shafts 24; since the configuration is the same as that of the first embodiment, the detailed description thereof is omitted.

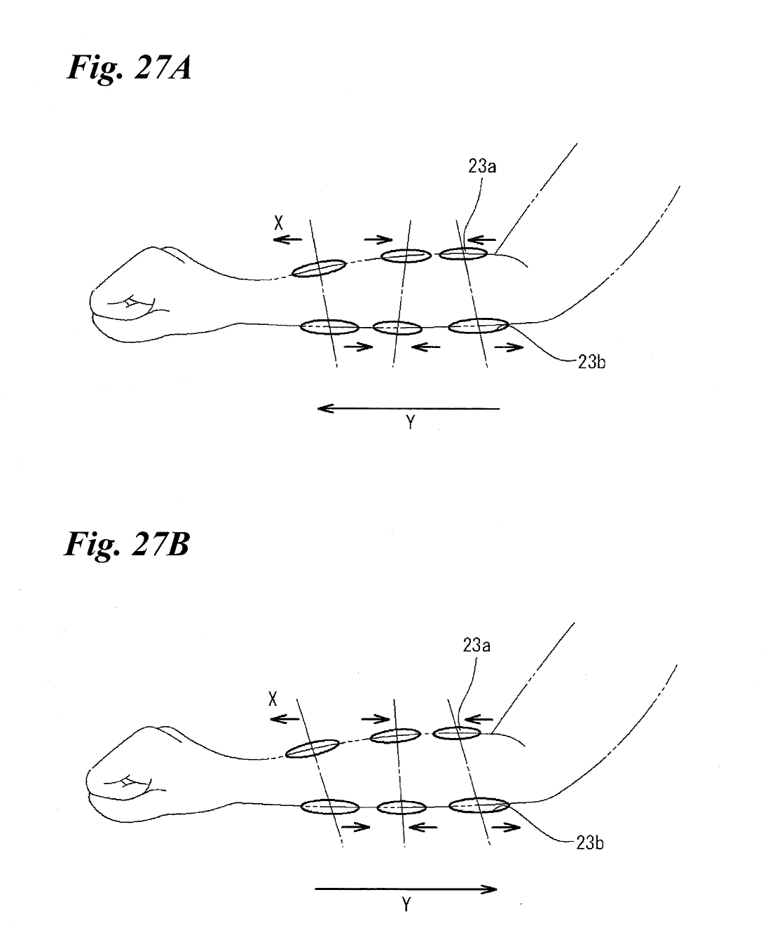

FIGS. 27A and 27B show the stroke massaging motion of the arm massage machine 7. The reciprocation movements of the air cells 23a and 23b are indicated by arrows X, and the movement of the massaging mechanism 20 is indicated by arrow Y. FIG. 27A shows a state in which the massaging mechanism 20 is moving from backward to forward (the position is changed in the second direction) as indicated by arrow Y.

In this case, the air cells 23a and 23b hold an arm therebetween in the up-down direction by the biasing portions 26 (not shown), and the air cells 23a and 23b make contact with the arm along the contour thereof. During the movement of the massaging mechanism 20 from backward to forward, the air cells 23a and 23b repeat the reciprocation movement in the front-rear direction to apply a constant pressing stimulus to the arm in the contact range therebetween. The air cell 23a changes the movement direction thereof from forward to backward and then to forward. Furthermore, the air cell 23b moves reversely with respect to the air cell 23a and changes the movement direction thereof from backward to forward direction and then to backward.

FIG. 27B shows a state in which the massaging mechanism 20 is moving from forward to backward (the position is changed in the second direction) as indicated by arrow X. Also in this case, the air cells 23a and 23b hold the arm therebetween in the up-down direction by biasing portions 26 (not shown), and the air cells 23a and 23b make contact with the arm along the contour thereof. During the movement of the massaging mechanism 20 from forward to backward, the air cells 23a and 23b repeat the reciprocation movement in the front-rear direction to apply the constant pressing stimulus to the arm in the contact range therebetween.

The air cell 23a changes the movement direction thereof from forward to backward and then to forward. Furthermore, the air cell 23b moves reversely with respect to the air cell 23a and changes the movement direction thereof from backward to forward direction and then to backward.

As described above, the constant pressing stimulus can be applied to the arm at all times by the biasing portions 26 (not shown) even at the front and rear portions of the arm, being different in size, and the air cells 23a and 23b can be moved along the contour of the arm while making contact with the arm at all times. Moreover, stroke massage can be performed in a wider range by repeating the stroke massaging motion while the movement is carried out in the front-rear direction of the arm.

The right arm massage machine 7 has been described in FIGS. 25 to 27B; since the left arm massage machine 7 has the same configuration as that of the right arm massage machine 7, except that the respective components thereof are just opposite in the left-right direction, the detailed description thereof is omitted. Furthermore, since the left and right leg massage machines 6 are installed not on the armrest main body portion 5a but on the leg placement main body portion 4b, the structure for the installation is different from that of the arm massage machine 7; however, since the basic configurations are the same in other respects, the detailed descriptions thereof are omitted.

FIG. 28 shows an example of a control circuit 30 provided for the left and right arm massage machines 7 according to the fifth embodiment. As shown in FIG. 28, the control circuit 30 includes the control portion 31, a remote controller 32, the detection portion 107, the drive units 28, the position changing drive portion 106, solenoid valves 35, an air supplying/exhausting apparatus 36, and the air cells 23a and 23b.

Each of the solenoid valves 35 is provided for each pair of the air cells 23a and 23b of the left and right arm massage machines 7 so that the respective solenoid valves can perform air supply and exhaust independently.

As described above, in the arm massage machine according to the fifth embodiment, the pair of air cells disposed opposite to each other holds the treatment site therebetween. And, the pair of air cells not only reciprocates together in a constant range in the longitudinal direction of the treatment site but also moves simultaneously in the longitudinal direction of the treatment site, whereby the treatment site can be stroked entirely in the longitudinal direction thereof. For this reason, stroke massage can be performed on the treatment site in a range wider than that in the first embodiment, and the user can get a more favorable stroke massage effect.

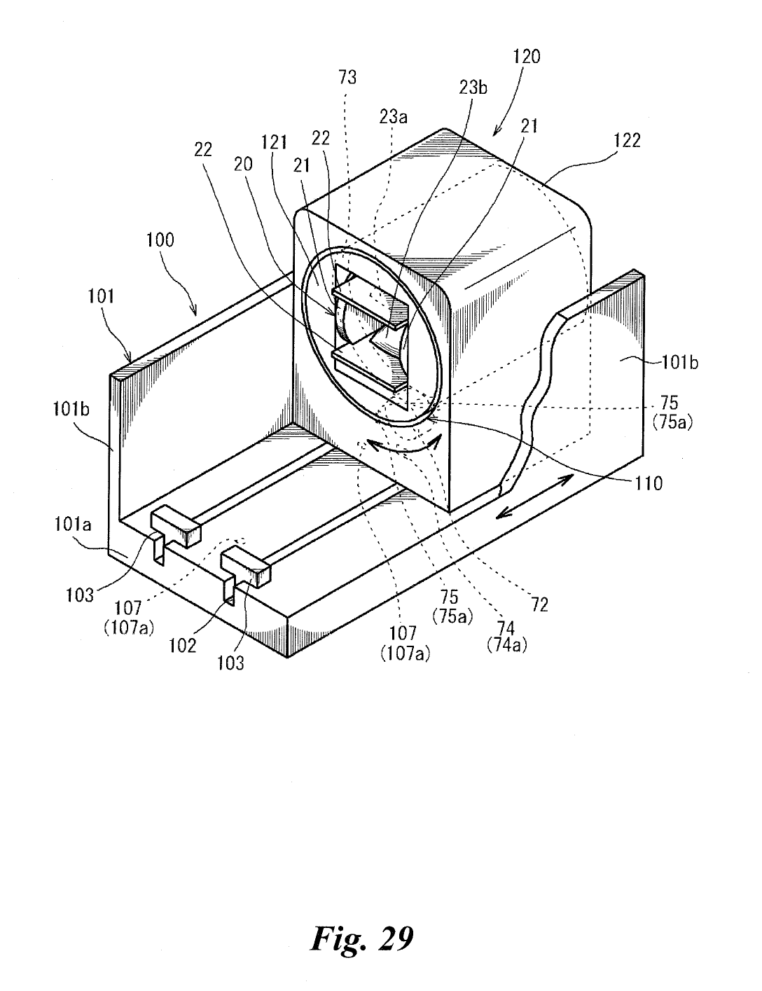

FIG. 29 shows a sixth embodiment of a massage machine according to the present invention.

The right arm massage machine 7 shown in FIG. 29 is equipped with the above-mentioned massaging mechanism 20, a pressing direction adjustment portion 110 having a gear mechanism, not the same as that of the above-mentioned pressing direction adjustment portion 70, for rotating the massaging mechanism 20 in the circumferential direction of a treatment-site arm (for changing the first direction), an outer frame 120 accommodating the massaging mechanism 20 and being movable (for changing the position in the second direction) in the front-rear direction, that is, in the longitudinal direction of the arm, and the stroke range adjustment portion 100 for moving the outer frame 120 to change the stroke position.

The outer frame 120 has an accommodation portion 121 for accommodating the massaging mechanism 20 and a rotation support portion 122 for supporting the accommodation portion 121 rotating in the circumferential direction of the arm.

The accommodation portion 121 has a cylindrical shape in the front-rear direction, and a rectangular space opened in the front-rear direction at the center portion of the circle of this cylinder. The massaging mechanism 20 is accommodated in the rectangular space. Inside the accommodation portion 121, a drive chamber (not shown) for accommodating the drive unit of the massaging mechanism 20 is provided.

The rotation support portion 122 has a rectangular shape and has a cylindrical space opened in the front-rear direction at the center portions in the left-right direction and the up-down direction. The accommodation portion 121 is rotatably accommodated in the cylindrical space of the rotation support portion 122.

The stroke range adjustment portion 100 is equipped with a guide portion 101 installed on the armrest main body portion 5a, guide grooves 102 for guiding the front-rear direction movement of the accommodation portion 121, locking portions 103 for restricting the front-rear direction movement of the accommodation portion 121 within a given range, and a movement mechanism 104 (not shown) for moving the accommodation portion 121 and the massaging mechanism 20 in the front-rear direction. The movement mechanism 104 (not shown) is equipped with rollers rotatably installed on the bottom face of the rotation support portion 122, a position changing drive portion accommodated inside the rotation support portion 122 to apply a rotation drive force to the rollers, and a detection portion for detecting the movement position of the rotation support portion 122. Since the stroke range adjustment portion 100 and the movement mechanism 104 (not shown) have the same configurations as those according to the fifth embodiment in other respects, the detailed descriptions thereof are omitted.

The massaging mechanism 20 is equipped with a pair of air cells 23 disposed opposite to each other at a given distance therebetween in the up-down direction, a pair of support plates (a first support: a support member) 22 for supporting the pair of air cells 23 from the outside in the up-down direction, a pair of rotation portions (a second support: a support member) 21 for applying a drive force to the pair of support plates 22 in the front-rear direction (the second direction) and for supporting the support plates 22 on both the left and right sides, guide portions 25 formed in the pair of rotation portions 21 to support the pair of support plates 22 so that the pair of support plates 22 is movable in a direction (the first direction) in which the support plates 22 approach and separate from each other, biasing portions 26 for biasing the pair of support plates 22 in a direction in which the support plates approach each other, rotation shafts 24 provided in the pair of rotation portions 21, and a drive unit 28 for applying a rotation drive force to the rotation shafts 24; since the configuration is the same as that of the first embodiment, the detailed description thereof is omitted.

The pressing direction adjustment portion 110 is equipped with the pressing direction adjustment portion 70, the gear 73 of the pressing direction adjustment portion 70 is formed on the outer circumferential surface of the accommodation portion 121 along the front circumference thereof, and the proximity switches 75a of the detection portion 75 are embedded in the accommodation portion 121 and the rotation support portion 122. The proximity switches 75a embedded in the accommodation portion 121 and the rotation support portion 122 are disposed at positions opposed to each other in the radial direction when the pressing direction adjustment portion 110 is in a stationary state. The pressing direction adjustment portion 70 is equipped with a pinion 72 installed in the rotation support portion 122 to rotate the accommodation portion 121 in the circumferential direction, a gear 73 provided on the outer circumferential surface of the accommodation portion 121 to mesh with the pinion 72, a pressing direction adjustment drive portion 74 for driving the pinion 72, and a detection portion 75 for detecting the rotation position of the accommodation portion 121; since the configuration is the same as that according to the third embodiment, the detailed description thereof is omitted.

In this case, the gear 73 rotates by the rotation of the pinion 72, and the accommodation portion 121 rotates in the circumferential direction; hence, the accommodation portion 121 can rotate one revolution or more in the circumferential direction. The accommodation portion 121 may be controlled so as to rotate through approximately a half circumference in the forward-reverse direction by means of the detection portion 75. In this case, air tubes (not shown) for supplying/exhausting air to the air cells 23a and 23b can be made shorter.

Furthermore, when the proximity switches 75a embedded in the accommodation portion 121 and the rotation support portion 122 are located at positions opposed to each other in the radial direction, the detection portion 75 can change the direction of the rotation drive force of the pressing direction adjustment drive portion 74 to the reverse direction or can maintain the direction of the rotation drive force of the pressing direction adjustment drive portion 74.

When the direction of the rotation drive force of the pressing direction adjustment drive portion 74 is maintained, by the circumferential direction movement of the pressing direction adjustment portion 110 and the front-rear direction movement of the movement mechanism 104, the air cells 23a and 23b of the massaging mechanism 20 can move helically around the arm in addition to the front-rear direction reciprocation movement.

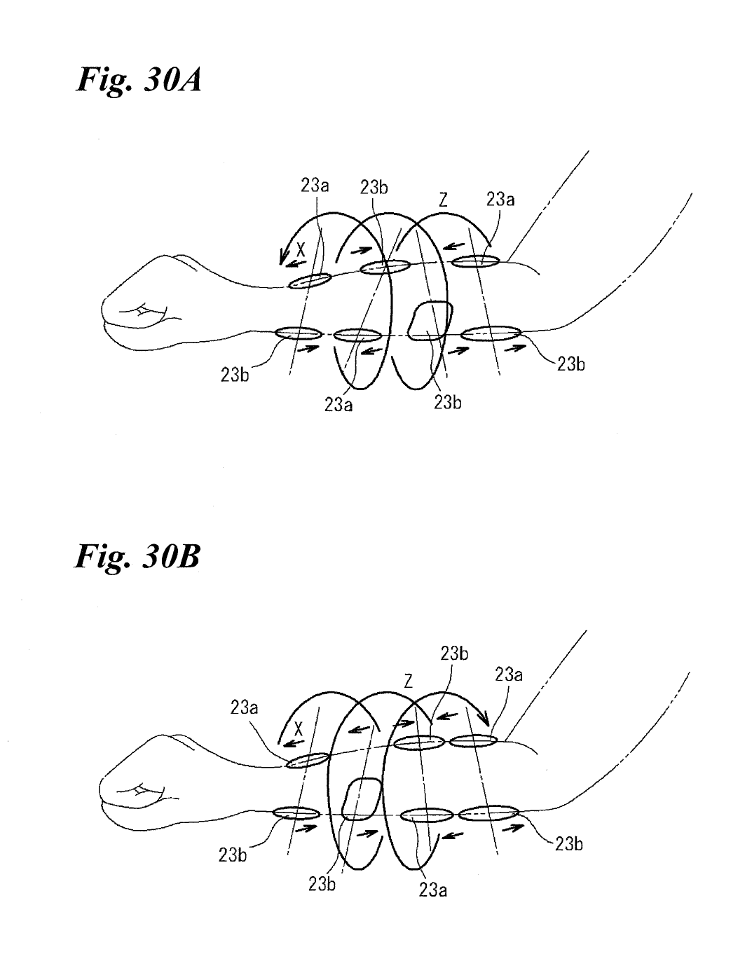

FIGS. 30A and 30B show the stroke massaging motion of the arm massage machine 7.

In this case, the reciprocation movements of the air cells 23a and 23b are indicated by arrows X, and the helical movement of the massaging mechanism 20 is indicated by arrow Z. FIG. 30A shows a state in which the massaging mechanism 20 is moving helically from backward to forward (the position is changed in the first direction and then in the second direction) as indicated by arrow Z.

In this case, the air cells 23a and 23b hold an arm therebetween in the up-down direction by the biasing portions 26 (not shown), and the air cells 23a and 23b make contact with the arm along the contour thereof. During the helical movement of the massaging mechanism 20 from backward to forward, the air cells 23a and 23b repeat the reciprocation movement in the front-rear direction to apply a constant pressing stimulus to the arm in the contact range therebetween. The air cell 23a changes the movement direction thereof from forward to backward and then to forward. Furthermore, the air cell 23b moves reversely with respect to the air cell 23a and changes the movement direction thereof from backward to forward direction and then to backward.

FIG. 30B shows a state in which the massaging mechanism 20 is moving helically backward (the position is changed in the first direction and then in the second direction) as indicated by arrow Z. Also in this case, the air cells 23a and 23b hold the arm therebetween in the up-down direction by the biasing portions 26 (not shown), and the air cells 23a and 23b make contact with the arm along the contour thereof. During the helical movement of the massaging mechanism 20 from forward to backward, the air cells 23a and 23b repeat the reciprocation movement in the front-rear direction to apply the constant pressing stimulus to the arm in the contact range therebetween. The air cell 23a changes the movement direction thereof from forward to backward and then to forward. Furthermore, the air cell 23b moves reversely with respect to the air cell 23a and changes the movement direction thereof from backward to forward direction and then to backward.

As described above, the constant pressing stimulus can be applied to the arm at all times by the biasing portions 26 (not shown) even at the front and rear portions of the arm, being different in size, and the air cells 23a and 23b can be moved helically along the contour of the arm while making contact with the arm at all times. Moreover, stroke massage can be performed in a wider range by repeating the stroke massaging motion while the movement is carried out in the front-rear direction and in the circumferential direction of the arm.

The right arm massage machine 7 has been described in FIGS. 29 to 30B; since the left arm massage machine 7 has the same configuration as that of the right arm massage machine 7, except that the respective components thereof are just opposite in the left-right direction, the detailed description thereof is omitted. Furthermore, since the left and right leg massage machines 6 are installed not on the armrest main body portions 5a but on the leg placement main body portion 4b, the structure for the installation is different from that of the arm massage machine 7; however, since the basic configurations are the same in other respects, the detailed descriptions thereof are omitted.

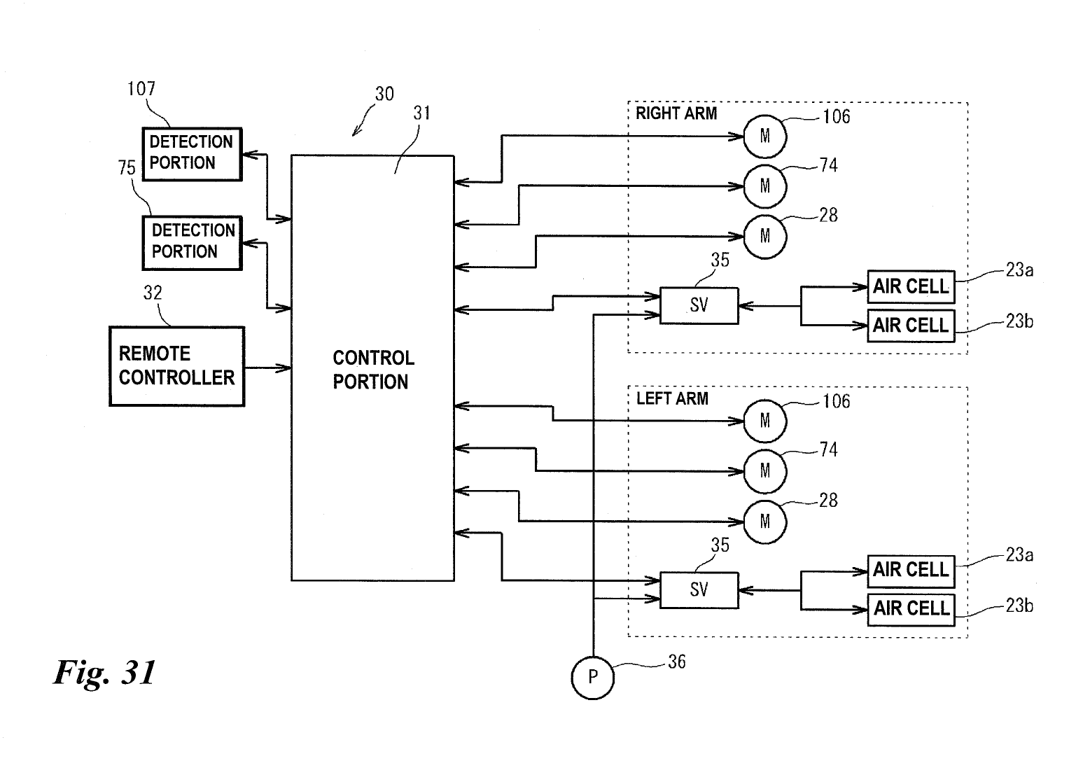

FIG. 31 shows an example of a control circuit 30 provided for the left and right arm massage machines 7 according to the sixth embodiment. As shown in FIG. 31, the control circuit 30 includes a control portion 31, a remote controller 32, the detection portion 75, the detection portion 107, the drive units 28, the pressing direction adjustment drive portion 74, the position changing drive portion 106, solenoid valves 35, an air supplying/exhausting apparatus 36, and the air cells 23a and 23b.

Each of the solenoid valves 35 is provided for each pair of the air cells 23a and 23b of the left and right arm massage machines 7 so that the respective solenoid valves can perform air supply and exhaust independently.

As described above, in the arm massage machine according to the sixth embodiment, the pair of air cells disposed opposite to each other holds the treatment-site arm therebetween, and the pair of air cells not only reciprocates together in a constant range in the longitudinal direction of the treatment site but also can rotate in the circumferential direction of the treatment site wile moving in the longitudinal direction of the treatment site, thereby being capable of helically stroking the treatment site. Furthermore, the treatment site can be stroked entirely in the longitudinal direction and circumferential direction thereof. For this reason, stroke massage can be performed on the treatment site in a range wider than that in the first embodiment, and the user can get a more favorable stroke massage effect.

Further, the present invention is not limited to the above-mentioned embodiments.

For example, although the pressing members are formed of the plate-shaped treatment devices 43 in the second embodiment, the pressing members may be formed of the air cells 23, and the pressing members formed of the air cells 23 in the other embodiments may also be used as the treatment devices 43.

In addition, the arrangement and the number of the air cells provided on the respective support plates 22 can be changed as necessary.

Furthermore, for example, the biasing portions 26 operating with air can be adopted as the biasing portions for biasing the pressing members. In the biasing portions 26 operating with air, air is supplied to the air cells 23a and 23b serving as the pressing members, whereby the air cells 23a and 23b are made contact with the treatment site at all times and can perform stroke massage to apply pressing stimulus at all times.

As described above, the present invention can be implemented in various embodiments within the scope of the invention without departing from the gist thereof.

As described above, according to the present invention, the pressing members disposed opposite to each other can hold the treatment site therebetween from both sides and both the pressing members can reciprocate together, thereby being capable of performing stroke massage efficiently; in addition, both the pressing members can make contact with the treatment site at all times and can perform stroke massage to apply pressing stimulus at all times, whereby a favorable stroke massaging effect can be obtained.

1. A massage machine comprising:
a first pressing member;
a second pressing member disposed to be opposed to the first pressing member with a distance so that a treatment site is disposed therebetween;
a support member that supports both the pressing members so that both the pressing members are movable in a first direction in which both the pressing members approach and separate from each other and in a second direction nearly perpendicular to the first direction;
biasing portions that bias both the pressing members in the direction in which both the pressing members approach each other; and
a stroke drive unit that performs a stroke massage on the treatment site using both the pressing members by respectively reciprocating both the pressing members biased using the biasing portions in the second direction.

2. The massage machine of claim 1,
wherein the support member includes:
a first support member provided to support the pressing members so as to be movable in the first direction together with the pressing members; and
a second support member supporting the first support member so as to move the first support member in the second direction by being driven by the drive unit, and
wherein the second support member has a guide portion to support the first support member so as to be movable in the first direction.

3. The massage machine of claim 1,
wherein the support member is configured so that an opposed distance between the first pressing member and the second pressing member is adjustable.

4. (canceled)

5. The massage machine of claim 1, further comprising:
a pressing direction adjustment portion that changes the first direction in which both the pressing members approach and separate from each other.

6. The massage machine of claim 5,
wherein the pressing direction adjustment portion further includes:
a pressing direction adjustment drive portion that generates a drive force to change the first direction; and
a control portion that changes the first direction by operating the pressing direction adjustment drive portion while performing the stroke massage on the treatment site using both the pressing members by driving the stroke drive unit.

7. The massage machine of claim 1, further comprising:
a stroke range adjustment portion that moves a stroke range in which both the pressing members reciprocate in the second direction by the stroke drive unit in the second direction.

8. (canceled)

9. (canceled)

10. The massage machine of claim 7,
wherein the stroke range adjustment portion further includes:
a position changing drive portion that generates a drive force to move the stroke range in the second direction; and
a control portion that moves the stroke range in the second direction by operating the position changing drive portion while performing the stroke massage on the treatment site using both the pressing members by driving the stroke drive unit.

11. (canceled)

12. (canceled)

13. The massage machine of claim 1, further comprising:
a pressing direction adjustment portion including:
a pressing direction adjustment drive portion that generates a drive force to change the first direction in which both the pressing members approach and separate from each other; and
a control portion that changes the first direction by operating the pressing direction adjustment drive portion while performing the stroke massage on the treatment site using both the pressing members by driving the stroke drive unit; and
a stroke range adjustment portion including:
a position changing drive portion that generates a drive force to move a stroke range in which both the pressing members reciprocate in the second direction by the stroke drive unit in the second direction; and
a control portion that moves the stroke range in the second direction by operating the position changing drive portion while performing the stroke massage on the treatment site using both the pressing members by driving the stroke drive unit.

14. A chair-type massage apparatus provided with:
The massage machine in claim 1 so as to be able to perform the stroke massage on the treatment site of the user sitting thereon.
